(19) United States
(12) Patent Application Publication
(10) Pub. No.: US 2013/0234553 A1
(43) Pub. Date: Sep. 12, 2013

(54) MAGNETIC MODULATION MOTOR AND ELECTRIC TRANSMISSION

(71) Applicant: DENSO CORPORATION, Kariya-city (JP)

(72) Inventors: Shin KUSASE, Obu-shi (JP); Yousuke KANAME, Obu-shi (JP); Naoto SAKURAI, Nagoya (JP)

(73) Assignee: DENSO CORPORATION, Kariya-city (JP)

(21) Appl. No.: 13/793,382

(22) Filed: Mar. 11, 2013

(30) Foreign Application Priority Data
Mar. 9, 2012 (JP) 2012-053227
Aug. 8, 2012 (JP) 2012-176329
Sep. 12, 2012 (JP) 2012-200426

(51) Int. Cl. H02K 16/02

(52) U.S. Cl. CPC H02K 16/02
USPC 310/114

(57) ABSTRACT

A magnetic modulation motor includes an armature, a magnetic induction rotor, and a magnet rotor. The armature is provided with a multi-phase winding with m pole pairs. The magnetic induction rotor includes k magnetic paths. In the magnet rotor, 2n permanent magnets forming a polarity region with n pole pairs are separately and annularly placed. The armature, the magnet rotor, and the magnetic induction rotor are arranged in the order from a radially outer side to a radially inner side. In the magnetic induction rotor, the magnetic path has two ends projecting toward a magnetic flux entry and exit located at an outer diameter face of the magnetic induction rotor, and forms a magnetic flux path between the magnetic flux entry and exit. The magnet rotor includes magnetic flux penetration region magnetically penetrated by magnetic flux between each circumferentially adjacent two permanent magnets.

### CROSS-REFERENCE TO RELATED APPLICATION

This application is based on and claims the benefit of priority from earlier Japanese Patent Application Nos. 2012-053227 filed Mar. 9, 2012, 2012-176329 filed Aug. 8, 2012, and 2012-200426 filed Sep. 12, 2012, the descriptions of which are incorporated herein by reference.

### BACKGROUND

1. Technical Field

The present invention relates to a magnetic modulation motor and an electric transmission suitable for use in a power device for hybrid vehicles which are driven by a mechanical power of an internal combustion and an electric power of a battery.

2. Description of the Related Art

As related art of a power transmission device for hybrid automobiles, there is a commonly used device which transmits power via a motor and a CVT (continuously variable transmission) between an output shaft of an internal combustion and an input shaft of a gear that switches between speed reduction and back-and-forth motion. Recently, new technologies combining these functions are proposed.

For example, there is known a motor with hybrid functions that includes an armature corresponding to a stator, a magnet rotor fixed to a first rotary shaft, and a magnetic induction rotor fixed to a second rotary shaft. Based on a principle of magnetic modulation, this motor smoothly converts speed between the first rotary shaft and the second rotary shaft, or adds an electric power to the second rotary shaft and outputs it. For example, JP-A-2010-017032 discloses a technique for achieving the hybrid functions as describe above.

The motor based on the principle of magnetic modulation (hereinafter referred to as “magnetic modulation motor”) has been evolved from the study of magnetic gears by Professor Kais Atallah, the university of Sheffield of the United Kingdom, et al. This motor has a basic structure including an outer rotor, an inner rotor, and a plurality of soft magnetic materials for magnetic induction poles. The outer rotor comprises a plurality of permanent magnets with m pole pairs. The inner rotor comprises a plurality of permanent magnets with n pole pairs. The number of the soft magnetic materials is determined by the sum or difference of m and n. The soft magnetic materials are used as the magnetic induction poles, which are arranged between the outer and inner rotors in such a way as to modulate magnetic field acting between both rotors through their permanent magnets.

A motor using an outer rotor as an armature of winding type follows the same principle of the magnetic modulation as described above.

The structure disclosed in JP-A-2010-017032 as described above includes an armature, a magnet rotor, and a magnetic induction rotor. The armature comprises a plurality of multi-phase windings with m pole pairs (m=8 in this case). The magnet rotor comprises a plurality of permanent magnets with n of pole pairs (n=8 in this case). The magnetic induction rotor is provided with k soft magnetic materials which are used as the magnetic induction poles and are circumferentially arranged between the armature and the magnet rotor (k=16 in this case). This structure is designed for the magnetic modulation motor of k=m+n (m=n=8 and k=16 in this case).

However, the magnetic modulation motor as described above has the following issues.

In JP-A-2010-017032, the magnetic induction poles of the magnetic induction rotor need to be made of discrete soft magnetic materials due to functional requirements. In the structure of the magnetic modulation motor, the magnetic induction rotor is located between the armature and the magnet rotor in a rotatable manner. Due to this structure, magnetic flux passes through a part of the magnetic induction rotor. If a metallic member is present around the magnetic induction pole, it acts as a shorting coil and then short-circuit current flows. This prevents the magnetic flux from passing through the part of the magnetic induction rotor and leads to generation of large loss. This is why the magnetic induction rotor has a difficulty in casting soft magnetic material by a method such as aluminum die casting commonly used in well-known motors. Thus, the magnetic induction rotor has a difficulty in ensuring mechanical rigidity and in being fixed to the rotary shaft, which causes a fundamental issue that proof stress is low.

A design of magnet fixation can be comparatively easily realized by the case where the magnetic induction rotor is arranged at the most inner diameter side at which the magnetic modulation motor is likely to be fixed to the rotary shaft. This is because a design of strong structure can be adopted. For example, it is possible to adopt such a structure design that a plurality of magnets are embedded in laminated iron cores and are connected by bridges without need for considering leakage of magnetic flux between the magnetic poles. This is because the magnet rotor is not as sensitive as the magnetic modulation motor and is a source of field magnetomotive force which provides magnetic flux using strong rare-earth magnets.

However, in the case where the magnetic induction rotor is arranged at the most inner diameter side, there is a problem that preferable magnetic modulation is not established.

In order to solve the problem, in the case where the magnet rotor is arranged between the armature and the magnetic induction rotor, the presence or absence of magnetic modulation action and problems are examined by the present inventors, and then, the following findings and solutions are obtained.

In the case where the magnet rotor is arranged between the armature and the magnetic modulation motor, a preferable magnetic modulation cannot be obtained and motor characteristics are greatly reduced. This cause is described below.

The magnet itself is a source of magnetomotive force, i.e., a source of magnetic flux, and has a low permeability as similar to that of air. Then, even if the magnetic induction poles modulate magnetic flux of the magnet depending on the number of poles, the magnet stands in a path of the modulated magnetic flux going toward the armature or returning from it, and is an obstacle in the path of the modulated magnetic flux. Therefore, the permanent magnet with strong magnetomotive force blocks the modulated magnetic flux over a widely-covered range, thereby disturbing the modulated magnetic flux.

On the other hand, in related art, as a transmission for hybrid vehicles, there is known a power conversion technique that combines two motors: (i) a magnetic modulation motor having two rotors and one stator; and (ii) a magnet motor having one rotor and one stator, which are well known. By such motors, high-speed low-torque power of an engine is converted into low-speed high-torque power, and then the converted power is transferred to an axle side.

As described above, the magnetic modulation rotor is derived from a combination of the principle of magnetic modulation and a magnetic gear transmitting power in non-contact manner, as described above. This basic structure includes: (i) an outer rotor with a plurality of permanent magnets having m pole pairs; (ii) an inner rotor with a plurality of permanent magnets having n pole pairs; and (iii) a magnetic modulation element located between the outer rotor and the inner rotor. The magnetic modulation element is made of m±n soft magnetic material segments, and magnetically modulates magnetic field acting between the outer and inner rotors through their magnets.

For example, JP-B2-4505524 discloses a case of a first rotary machine corresponding to the magnetic modulation motor. The first rotary machine includes: (i) a stator of winding type that is configured by the outer rotor of the magnetic modulation motor; and (ii) first and second rotors that are located in a relatively rotatable manner with respect to the stator. For example, an input shaft of the second rotor is directly coupled to a crank shaft of an engine, and an output shaft of the first rotor is coupled to driven unit (axel side) via a gear mechanism or the like.

The first rotor includes a plurality of magnetic poles located in such a way as to face an armature of the stator. The magnetic poles are circumferentially arranged at intervals, and the adjacent two magnetic poles differ in polarity from each other.

The second rotor includes a plurality of soft magnetic materials located between the armature of the stator and the magnetic poles of the first rotor. The soft magnetic materials are circumferentially arranged at intervals.

In addition to the first rotary machine, JP-B2-4505524 also discloses a second rotary machine which is a well-known magnet motor. In this disclosure, the following cases are described.

(1) In the first case, the first and second rotary machines are axially arranged on an output shaft.

(2) In the second case, the first rotary machine is arranged at the radially outer side of the second rotary machine. In this case, the first and second rotary machines are radially arranged. This can downsize an axial size of the power device, thereby making it possible to increase its design freedom.

(3) In the third case, the first and second rotary machines are separately arranged (mounted). For example, the first rotary machine is used as a power source for front-wheel drive, and the second rotary machine is used as a power source for rear-wheel drive.

As describe above, JP-B2-4505524 discloses a technique of the power device that generates drive power and converts speed by combining the first rotary machine corresponding to the magnetic modulation motor and the second rotary machine which is a well-known magnet motor.

In the first rotary machine disclosed in JP-B2-4505524, a relationship of (i) a velocity (speed) of rotating magnetic field, (ii) a rotational velocity of the first rotary machine, and (iii) a rotational velocity of the second rotary machine can be expressed by collinear diagram used in explanation of operation of a well-known mechanical planetary gear motor. In other words, this first rotary machine can be operated in the same manner as the mechanical planetary gear motor.

The mechanical planetary gear motor transmits power through gears meshing with each other. This requires oil lubrication, thereby resulting in low transmission efficiency. Compared to this, in the magnetic modulation motor such as the first rotary machine described above, the stator and the rotor operate in a non-contact manner. Therefore, the magnetic modulation motor is expected to be an advantageous technique capable of using a substitute for the mechanical planetary gear motor.

In order for the above-expected technique to be embodied, design and realization of an electric transmission using a combination of a magnetic modulation motor and a magnet motor were also examined by the present inventors, and then, the following findings and solutions were obtained.

In the configuration disclosed in JP-B2-4505524, a body of the first and second rotary machines is likely to be large, and then, it is difficult to realize two rotors as above-described in the second case in which the first and second rotary machines are radially arranged. As a result of analyzing this cause, it is found that the technique disclosed in JP-B2-4505524 has the following issues.

The configuration of the first rotary machine makes it difficult to downsize the first and second rotary machines (especially, the first rotary machine corresponding to the magnetic modulation motor). In the magnetic modulation motor in related art, the magnetic modulation element is located between the armature and the field element. In the case of the first rotary machine disclosed in JP-B2-4505524, the second rotor (configuring the magnetic modulation element) is located between the stator (configuring the armature) and the first rotor (configuring the field element).

In this configuration, the magnetic modulation element is positioned in a path of magnetic flux going and returning between the armature and the field element. This causes eddy current in the magnetic modulation element. This also causes a current path in a metallic support structure that supports the magnetic modulation element. Thus, the eddy current circulates in a loop formed in the current path. Therefore, this makes it difficult to: (i) support, by a metallic member, a plurality of soft magnetic materials forming the magnetic modulation element, or (ii) support the magnetic modulation element by a support member to which the plurality of soft magnetic materials are directly connected by welding or fastening.

As this regard, an insulator such as resin is considered for a use of a support structure of the magnetic modulation element. However, the support structure uses resin or the like having a strength lower than metallic member, thereby being unable to resist high speed high vibration of an engine. In other words, the support structure of the magnetic modulation element is required to be large, in order to be able to resist high speed high vibration of the engine by using low strength resin or the like.

Therefore, the magnetic modulation element for causing operation of magnetic modulation is required to magnetically separate the plurality of soft magnetic materials from one another and to reliably support each of the soft magnetic materials. On the other hand, as described above, the magnetic modulation element is positioned in the path of magnetic flux going and returning between the armature and the field element, thereby causing generation of eddy current. This generation of eddy current makes it difficult to support the magnetic modulation element by using a metallic member.

In addition, in the configuration disclosed in JP-B2-4505524, two inverters called as PDU (power drive unit) are required, and then, it is also difficult to realize two rotors as above-described in the second case in which the first and second rotary machines are radially arranged.

In this regard, in JP-B2-4505524, the first rotary machine generates electric power and transmits the generated power to the second rotary machine in such a way as to regenerate power on its output shaft. In such a mode, two inverters are used for transmitting electric power with different frequency between the first and second rotary machines.

To deal with these issues described above, the magnetic modulation motor may be designed in such a way that the magnetic modulation element is not located between the armature and the field element, but is located outside them. However, this case has the following issues.

The rotary machine based on the principle of magnetic modulation is a non-synchronous machine. In such a non-synchronous machine, the armature and the field element, which differ from each other in the number of poles, are arranged adjacent to each other, thereby increasing magnetic interference between them so as to magnetically disturb each other. This makes it impossible for the magnetic modulation element to cause operation of magnetic modulation. This is why a rotary machine, in which the magnetic modulation element is located outside the armature and the field element, has not been proposed and put into practical use. Such a configuration of the rotary machine is excluded from the disclosures of JP-B2-4505524.

### SUMMARY

The present disclosure provides a magnetic modulation motor including a magnet rotor arranged between an armature and a magnetic induction rotor, which is able to improve a strength and proof stress of the magnetic induction rotor.

The present disclosure also provides an electric transmission configured by a first rotary machine using a magnetic modulation motor and a second rotary machine using a magnet motor, which is able to be downsized.

The present disclosure further provides an electric transmission configured by a first rotary machine using a magnetic modulation motor and a second rotary machine using an induction motor, in which the second rotary machine is able to be electrically driven by generated power of the first rotary machine, and which is able to be downsized.

According to first exemplary aspect of the present disclosure, there is provided a magnetic modulation motor, including: an armature provided with a multi-phase winding having m pole pairs, m being an integer of one or more; a magnetic induction rotor including k magnetic paths, k being an integer of one or more; and a magnet rotor in which 2n permanent magnets forming a polarity region of n pole pairs are separately and annularly placed, n being a sum or difference of m and k, 2n being twice n.

The armature, the magnet rotor, and the magnetic induction rotor are arranged in the order from a radially outer side to a radially inner side of the magnetic modulation motor.

In the magnetic induction rotor, each of the magnetic paths has both ends, each projecting toward a magnetic flux entry and exit located at an outer diameter face of the magnetic induction rotor, each of the magnetic paths forming a magnetic flux path between the magnetic flux entry and exit.

The magnet rotor includes a magnetic flux penetration region which is magnetically penetrated by magnetic flux between each circumferentially adjacent two permanent magnets.

In the magnetic modulation motor according to the first exemplary aspect, the magnetic induction rotor is located at the most inner diameter side, and the magnet rotor being a source of magnetomotive force is located between the magnetic induction rotor and the armature. Even for this arrangement, since the magnetic flux penetration region is provided in the magnet rotor, the modulated flux of the magnetic induction rotor is not disturbed even if facing the source of magnetomotive force in arrangement of the permanent magnets in the magnet rotor. Then, its penetrated component passes through the magnetic flux penetration region, and therefore, magnetic modulation action works with the armature.

Thus, even if the magnet rotor is present between the armature and the magnetic induction rotor, magnetic modulation action works well. Such a motor can be realized. Therefore, this motor can work as a modulation motor, though the magnetic induction rotor being a modulation element is located externally to the armature and the magnet rotor. In addition, the magnetic modulation rotor is located at the most inner diameter side, thereby being able to improve a strength and proof stress of the magnetic induction rotor.

According to second exemplary aspect of the present disclosure, there is provided an electric transmission, including: a first rotary machine including a first rotary shaft supported by a device frame via a first bearing in a rotatable manner; and a second rotary machine including a second rotary shaft supported by the device frame via a second bearing.

The first rotary machine includes: a first armature, a first field element, and a magnetic modulation element.

The first armature is fixed to the device frame, and has three-phase windings of m pole pairs, where m is an integer of one or more.

The first field element includes a plurality of permanent magnets. The permanent magnets is circumferentially arranged relative to the first armature via a gap in a rotatable manner. The permanent magnets form a plurality of magnetic poles of n pole pairs, where n is an integer of one or more. Each circumferentially adjacent two permanent magnets circumferentially adjacent two permanent magnets are magnetized so as to differ in polarity from each other. A soft magnetic material is located around the circumference of an opposite surface facing the first armature so as to cover an armature side surface of the permanent magnets and a space between each circumferentially adjacent two permanent magnets.

The magnetic modulation element includes m+n magnetic paths. The m+n magnetic paths are located relative to the first field element via a gap in a rotatable manner. The m+n magnetic paths form passes of magnetic flux. The m+n magnetic paths are magnetically separated from one another and being arranged.

The first field element is located between the first armature and the magnetic modulation element. The first field element and the magnetic modulation element configures two rotors, one of which being coupled to the first rotary shaft and being configured to rotate integrally with the first rotary shaft.

The second rotary machine includes: a second armature fixed to the device frame, the second armature having a three-phase winding; a second field element located with the second armature via a gap in a rotatable manner, the second field element circumferentially forming a plurality of magnetic poles, and the circumferentially adjacent two magnetic poles differing in polarity from each other.

The second field element is connected to the second rotary shaft via a connecting member, and is configured to rotate integrally with the second rotary shaft. In the first and second rotary machines, the second field element and the other of the first field element and the magnetic modulation element are mechanically connected to each other via the connecting member.

In the first rotary machine used in the electric transmission according to the second exemplary aspect, the first field element is located between the first armature and the magnetic modulation element. This is different from the magnetic modulation motor in related art in which the magnetic modulation element is located between the armature and the field element.

In addition, in the first field element, the soft magnetic material is located around the circumference of an opposite surface facing the first armature so as to cover an armature side surface of the permanent magnets and to also cover a space between the circumferentially adjacent two permanent magnets. Thus, magnetic field generated by the first armature of m pole pairs can be transmitted to the magnetic modulation element having m+n magnetic paths. As a result, the magnetic field of m+n−m=n pole pairs, generated by the magnetic modulation element, synchronizes in frequency with the first field element of n pole pairs. Then, torque is produced.

Therefore, even if the first field element is located between the first armature and the magnetic modulation element (this arrangement cannot be easily derived from related art), magnetic modulation action can effectively work.

In the first rotary machine, the magnetic modulation element is not located between the first armature and the first field element, but can be located at the opposite side of the first armature with respect to the first field element. Thus, magnetic flux passing though the magnetic paths of the magnetic modulation element forms a flow that passes though the magnetic paths and U-turns. This causes no generation of large loop eddy current, even if a metallic member is embedded between the m+n magnetic paths. In other words, the magnetic modulation element can be reliably and easily supported. This makes it possible to increase rotation speed of the first rotary machine and to downsize the first rotary machine.

Further, in the first and second rotary machine, one of two rotors (i.e., the first field element and magnetic modulation element) of the first rotary machine and the second field element of the second rotary machine are mechanically coupled to each other. This can provide the electric transmission with one compact body.

According to third exemplary aspect of the present disclosure, there is provided an electric transmission, including: a first rotary machine including a first rotary shaft supported by a device frame via a first bearing in a rotatable manner; and a second rotary machine including a second rotary shaft supported by the device frame via a second bearing.

The first rotary machine includes a first armature, a field element, and a magnetic modulation element.

The first armature including a first armature core fixed to the device frame, and first three-phase windings of m pole pairs that is wound around the first armature core, where m is an integer of one or more.

The field element includes a plurality of permanent magnets. The permanent magnets are circumferentially arranged relative to the first armature via a gap in a rotatable manner. The permanent magnets form a plurality of magnetic poles of n pole pairs, where n is an integer of one or more. Each circumferentially adjacent two permanent magnets are magnetized so as to differ in polarity from each other. A soft magnetic material are located around the circumference of an opposite surface facing the first armature so as to cover an armature side surface of the permanent magnets and a space between each circumferentially adjacent two permanent magnets.

The magnetic modulation element includes m+n magnetic paths. The m+n magnetic paths are located relative to the field element via a gap in a rotatable manner. The m+n magnetic paths form passes of magnetic flux. The m+n magnetic paths being magnetically separated from one another.

The field element is located between the first armature and the magnetic modulation element. The field element and the magnetic modulation element configures two rotors, one of which being configured to rotate integrally with the first rotary shaft via a first rotor disc.

The second rotary machine includes: a second armature including a second armature core fixed to the device frame and second three-phase windings that is wound around the second armature core; a squirrel-cage rotor located relative to the second armature via a gap in a rotatable manner. The squirrel-cage rotor is configured to rotate integrally with the second rotary shaft via a second rotor disc.

In the first and second rotary machines, the squirrel-cage rotor and the other of the field element and the magnetic modulation element are mechanically connected to each other. The first three-phase windings and the second three-phase windings are connected to each other in such a manner that their phase sequence is a negative sequence.

The electric transmission according to the third exemplary aspect includes the first and second rotary machines. The first rotary machine is configured by a magnetic modulation motor. The second rotary machine is configured by an induction motor. The armature of the first rotary machine is provided with the first three-phase windings. The armature of the second rotary machine is provided with the second three-phase windings. The first three-phase windings and the second three-phase windings are connected to each other in such a manner that their phase sequence is a negative sequence.

Then, for example, the engine is rotated at high speed and the axle is rotated at low speed, i.e., the first rotary machine generates electric power while the first three-phase windings generate a rotating magnetic field of the reverse direction of the rotational direction of the engine. By current due to this generated power, a rotating magnetic field of the positive direction is generated in the second three-phase windings of the second rotary machine. This rotating magnetic field induces magnetic field generated in the squirrel-cage rotor of the second rotary machine. Thus, the squirrel-cage rotor rotates in the positive direction with a slip.

As a result, the second rotary machine can be electrically driven by using the generated power of the first rotary machine, without a dedicated inverter.

Further, in the first rotary machine, the field element is located between the first armature and the magnetic modulation element. This is different from the magnetic modulation motor in related art in which the magnetic modulation element is located between the armature and the field element.

In addition, in the field element, the soft magnetic material is located around the circumference of an opposite surface facing the first armature so as to cover an armature side surface of the permanent magnets and a space between each circumferentially adjacent two permanent magnets. Thus, magnetic field generated by the first armature of m pole pairs can be transmitted to the magnetic modulation element having m+n magnetic paths. As a result, magnetic field of m+n−m=n pole pairs, generated by the magnetic modulation element, synchronizes in frequency with the field element of n pole pairs. Then, torque action works.

Therefore, even if the field element is located between the first armature and the magnetic modulation element (this arrangement cannot be easily derived from related art), magnetic modulation action can effectively work.

In the first rotary machine, the magnetic modulation element is not located between the first armature and the field element, but can be located at the opposite side of the first armature with respect to the field element. Thus, magnetic flux passing though the magnetic paths of the magnetic modulation element forms a flow that passes though the magnetic paths and U-turns. This causes no generation of large loop eddy current, even if metallic member is embedded between the m+n magnetic paths. In other words, the magnetic modulation element can be reliably and easily supported. This makes it possible to increase rotation speed of the first rotary machine and to downsize the first rotary machine.

Further, in the first and second rotary machine, one of two rotors (i.e., the field element and magnetic modulation element) of the first rotary machine and the squirrel-cage rotor of the second rotary machine are mechanically coupled to each other. This can provide the electric transmission with one compact body.

### BRIEF DESCRIPTION OF THE DRAWINGS

In the accompanying drawings:

FIG. 1 is an elevation view showing a radial half part of a magnetic modulation motor according to a first exemplary embodiment as viewed from its axial direction;

FIG. 2 is a schematic diagram showing an overall configuration of the magnetic modulation motor of FIG. 1;

FIG. 3 is a partial elevation view showing a part of the magnetic modulation motor of FIG. 1 as viewed from its axial direction;

FIG. 4 is a connection diagram showing an armature winding which is connected to an inverter in the magnetic modulation motor of FIG. 1;

FIG. 5A is a configuration diagram showing an analysis model for a motor in related art;

FIG. 5B is an a analysis diagram showing a simulation result in a magnetic field analysis for the analysis model of FIG. 5A;

FIG. 6A is a configuration diagram showing an analysis model for the magnetic modulation motor according to the first exemplary embodiment;

FIG. 6B is an a analysis diagram showing a simulation result in a magnetic field analysis for the analysis model of FIG. 6A;

FIG. 7A is a configuration diagram showing an analysis model A;

FIG. 7B is an a analysis diagram showing a simulation result in a magnetic field analysis for the analysis model A of FIG. 7A;

FIG. 8A is a configuration diagram showing an analysis model B;

FIG. 8B is an a analysis diagram showing a simulation result in a magnetic field analysis for the analysis model B of FIG. 8A;

FIG. 9A is a configuration diagram showing an analysis model C;

FIG. 9B is an a analysis diagram showing a simulation result in a magnetic field analysis for the analysis model C of FIG. 9A;

FIG. 10A is a configuration diagram showing an analysis model D;

FIG. 10B is an a analysis diagram showing a simulation result in a magnetic field analysis for the analysis model D of FIG. 10A;

FIG. 11 is an elevation view showing a radial half part of a magnetic modulation motor according to a second exemplary embodiment as viewed from its axial direction;

FIG. 12A is a configuration diagram showing an analysis model for the magnetic modulation motor according to the second exemplary embodiment;

FIG. 12B is an a analysis diagram showing a simulation result in a magnetic field analysis for the analysis model of FIG. 12A;

FIG. 13 is an elevation view showing a radial half part of a magnetic modulation motor according to a third exemplary embodiment as viewed from its axial direction;

FIG. 14A is a configuration diagram showing an analysis model for the magnetic modulation motor according to the third exemplary embodiment;

FIG. 14B is an a analysis diagram showing a simulation result in a magnetic field analysis for the analysis model of FIG. 14A;

FIG. 15A is a partial cross-sectional view showing a configuration of a magnetic modulation motor according to a fourth exemplary embodiment;

FIG. 15B is a circumferential development diagram showing a mounted state of a short-circuit coil in the magnetic modulation motor of FIG. 15A;

FIG. 16A is a partial cross-sectional view showing a configuration of a magnetic modulation motor according to a fifth exemplary embodiment;

FIG. 16B is a circumferential development diagram showing a mounted state in which a copper plate is fixed by a bolt in the magnetic modulation motor of FIG. 16A;

FIG. 17 is a longitudinal cross-sectional view showing an electrical transmission according to a sixth exemplary embodiment;

FIG. 18 is partial transverse cross-sectional view showing a first rotary armature, a first field element, and magnetic modulation element configuring a first rotary machine of the electrical transmission of FIG. 17;

FIG. 19 is partial transverse showing a second armature and a second field element configuring a second rotary machine of the electrical transmission of FIG. 17;

FIG. 20 is a schematic diagram showing an overall configuration of a hybrid vehicle provided with the electrical transmission of FIG. 17;

FIG. 21A is an explanatory diagram showing an engine start mode in the vehicle of FIG. 17;

FIG. 21B is a motion diagram of the first rotary machine in the mode of FIG. 21A;

FIG. 22A is an explanatory diagram showing an engine acceleration and axle activation mode in the vehicle of FIG. 17;

FIG. 22B is a motion diagram of the first rotary machine in the mode of FIG. 22A;

FIG. 23A is an explanatory diagram showing an EV (electric vehicle) drive mode in the vehicle of FIG. 17;

FIG. 23B is a motion diagram of the first rotary machine in the mode of FIG. 23A;

FIG. 24A is an explanatory diagram showing a vehicle regenerative braking mode in the vehicle of FIG. 17;

FIG. 24B is a motion diagram of the first rotary machine in the mode of FIG. 24A;

FIG. 25 is a longitudinal cross-sectional view showing an electrical transmission according to a seventh exemplary embodiment;

FIG. 26 is a longitudinal cross-sectional view showing an electrical transmission according to an eighth exemplary embodiment;

FIG. 27 is a diagram showing a overall configuration of the electrical transmission of FIG. 26;

FIG. 28 is a transverse cross-sectional view showing a structure of a first rotary machine of the electrical transmission of FIG. 26;

FIG. 29 is a transverse cross-sectional view showing a structure of a second rotary machine of the electrical transmission of FIG. 26;

FIG. 30 is a cross-sectional view taken along the line V-V of a squirrel-cage rotor in the second rotary machine of FIG. 29;

FIG. 31 is a schematic diagram showing an overall configuration of a hybrid vehicle provided with the electrical transmission of FIG. 26;

FIG. 32A is an explanatory diagram showing an engine start mode in the vehicle of FIG. 31;

FIG. 32B is a motion diagram of the first rotary machine in the mode of FIG. 32A;

FIG. 33A is an explanatory diagram showing an engine acceleration and axle activation mode in the vehicle of FIG. 31;

FIG. 33B is a motion diagram of the first rotary machine in the mode of FIG. 33A;

FIG. 34A is an explanatory diagram showing an EV (electric vehicle) drive mode in the vehicle of FIG. 31;

FIG. 34B is a motion diagram of the first rotary machine in the mode of FIG. 34A;

FIG. 35A is an explanatory diagram showing a vehicle regenerative braking mode in the vehicle of FIG. 31;

FIG. 35B is a motion diagram of the first rotary machine in the mode of FIG. 35A; and

FIG. 36 is a longitudinal cross-sectional view showing an electrical transmission according to a ninth exemplary embodiment.

### DESCRIPTION OF EMBODIMENTS

Hereinafter, referring to the drawing, exemplary embodiments according to the present invention will be described in detail.

### First Exemplary Embodiment

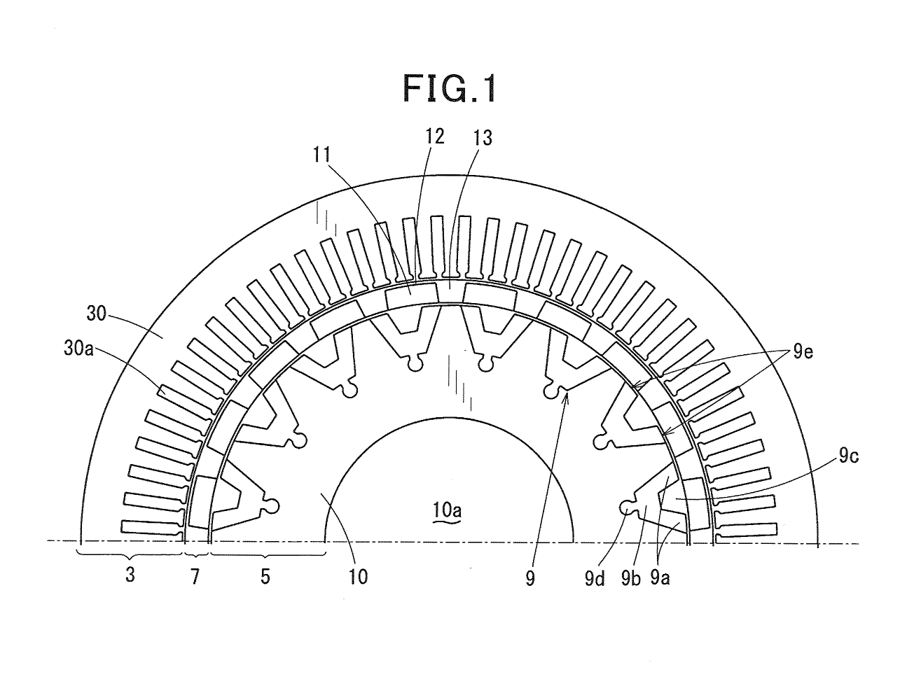

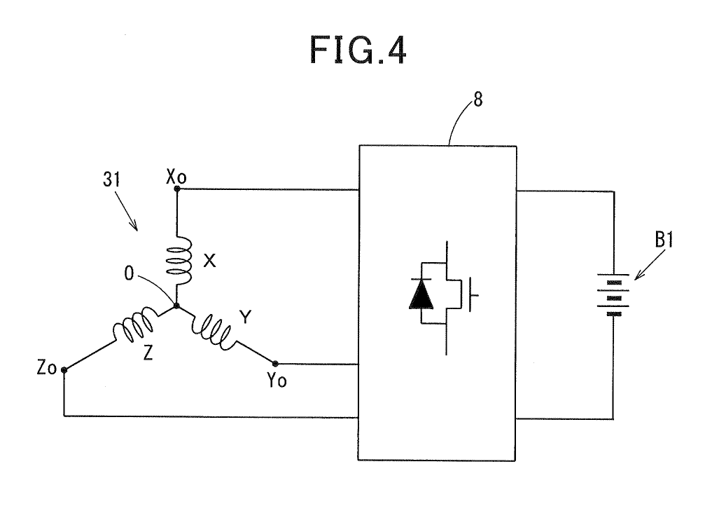

FIGS. 1 to 4 show a magnetic modulation motor (hereinafter referred to as “motor”) 1 according to a first exemplary embodiment of the present invention, which is mounted between an engine and a transmission in a hybrid vehicle.

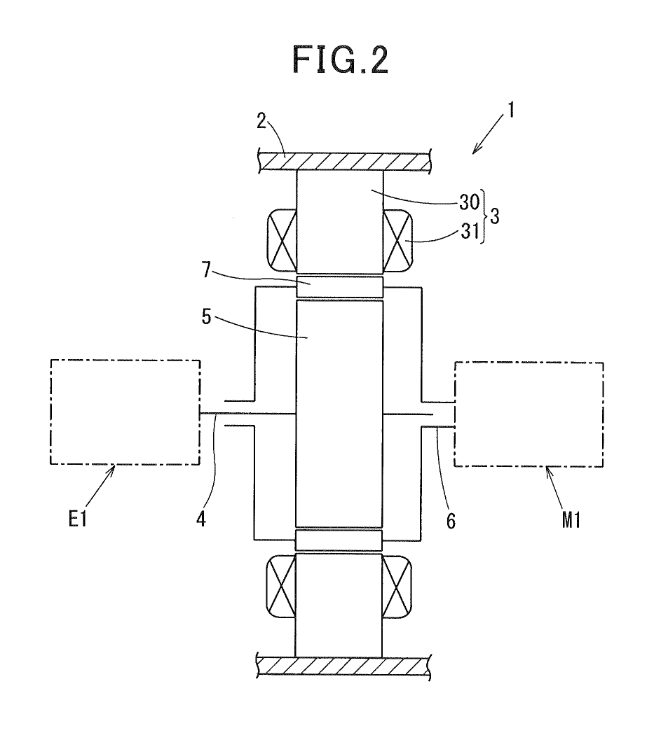

First, a configuration of the motor 1 is described. As shown in FIG. 2, the motor 1 includes a motor frame 2, an armature 3, a first rotary shaft 4, a magnetic induction rotor 5, a second rotary shaft 6, and a magnet rotor 7. The armature 3, the magnet rotor 7, and the magnetic induction rotor 5 are arranged in the order from the radially outer side to the radially inner side (center side) of the motor 1. The armature 3 is fixed to the motor frame 2. The first rotary shaft 4 is coupled with an output shaft of an engine E1, and is supported by the motor frame 2 in a rotatable manner via a bearing (not shown). The magnetic induction rotor 5 rotates integrally along with the first rotary shaft 4. The second rotary shaft 6 is coupled with an driven shaft of a transmission M1, and is supported by the motor frame 2 in a rotatable manner via bearings (not shown). The magnet rotor 7 rotates integrally along with the second rotary shaft 6.

### (Description of Armature 3)

The armature 3 is configured by an armature iron core 30 and an armature winding 31. The armature iron core 30 is configured by laminating a plurality of electromagnetic steel plates. The armature winding 31 is wound around the armature iron core 30.

As shown in FIG. 1, the armature iron core 30 has a radially inner periphery on which a plurality of slots (e.g., 72 slots in the first exemplary embodiment) are formed circumferentially at regular pitches.

The armature winding 31 is configured by three-phase (X-phase, Y-phase, and Z-phase) windings with m pole pairs (m=6 in the first exemplary embodiment). The three-phase windings are connected in a star configuration in which one end thereof are connected to one common neutral point O and the other end are connected to an inverter 8. The inverter 8 is a well-known power converter for converting direct current (DC) power into alternating current (AC) power, and is connected to a battery B1 which is a main power supply mounted in a vehicle. This inverter 8 is driven in a controlled manner by an inverter ECU (electronic control unit) that communicates signals with a vehicle control ECU (not shown).

### (Description of Magnetic Induction Rotor 5)

As shown in FIG. 1, the magnetic induction rotor 5 is configured by: (i) 16 segments (segment poles) 9 that form magnetic paths; and (ii) a rotor hub 10 that supports the 16 segments 9. In the present embodiment, the number of magnetic paths (formed by the segments) is given by k=16.

Each of the 16 segments 9 is configured by laminating a plurality of electromagnetic steel plates which are formed into an approximate V-shape by punching. The segments 9 are circumferentially arranged at predetermined intervals. Hereinafter, two sides of the segment 9 which are opened into a V-shape are referred to “two segment arm sections 9a”. A base (root) side of the two segment arm sections 9a is referred to “segment base section 9b”. A concave portion (e.g., a recess or hollow portion) formed between the two segment arm sections 9a is referred to “segment concave portion 9c”.

The segments 9 as described above are arranged in such a manner that the two segment arm sections 9a are open into a V-shape radially outward, i.e., the segment base section 9b faces radially inward. In the present embodiment, an anchor section 9d which has a dovetail-shape is formed in the bottom face of the segment base section 9b.

The rotor hub 10 is made of high-strength aluminum material (for example, duralumin) which is a non-magnetic and a good electric conductor, and is produced by die-casting in which the 16 segments 9 are integrally cast. Therefore, high-strength aluminum material is filled between two circumferentially adjacent segments 16 up to a position of its outer diameter face. In other words, two circumferentially adjacent segments 16 are magnetically separated from each other by high-strength aluminum material forming the rotor hub 10. Here, the segment concave portion 9c is not filled with aluminum material. The anchor section 9d, provided in the segment base section 9b, is buried in the rotor hub 10. Thus, each of the segments 9 is tightly fixed to the rotor hub 10. This prevents the segments 9 from being detached from the rotor hub 10.

In the rotor hub 10, a central hole 10a is formed in a radial inner periphery thereof. The first rotary shaft 4 is fitted into the central hole 10a of the rotor hub 10 by press fitting or the like, and then, the rotor hub 10 is fixed to the first rotary shaft 4.

In each of the 16 segments 9, an apical face of the respective segment arm sections 9a projects toward a “rotor outer diameter face”, and forms an entry and exit of magnetic flux. Here, the “rotor outer diameter face” is an outer diameter face of the magnetic induction rotor 5 which faces the magnet rotor 7 via a gap between the magnetic induction rotor 5 and the magnet rotor 7, and corresponds to an outer diameter face of aluminum material filled between the circumferentially adjacent two segments 9. Hereinafter, the apical face of the respective segment arm sections 9a projecting toward the rotor outer diameter face is referred to as a “magnetic flux entry and exit 9e”.

Each of the segments 9 is arranged at an angular range of a center angle θ1=22.5 degrees which is obtained by dividing 360 degrees of full circumference of the magnetic induction rotor 5 by 19 which is the number of segments 9. The magnetic flux entry and exit 9e of the segment arm section 9a projects toward the rotor outer diameter face at an angular range of a center angle θ2=4.5 degrees which is approximately ⅕ of the center angle θ1=22.5 degrees.

### (Description of Magnet Rotor 7)

As shown in FIG. 1, the magnet rotor 7 is configured by 20 permanent magnets made of rare-earth permanent magnets (e.g., neodymium magnets) 11 and soft magnetic materials 12, 13 which support the 20 permanent magnets 11. In the present embodiment, the number of poles (made of permanent magnets) is 2n=20, and the number of pole pairs (made of permanent magnets) is n=10.

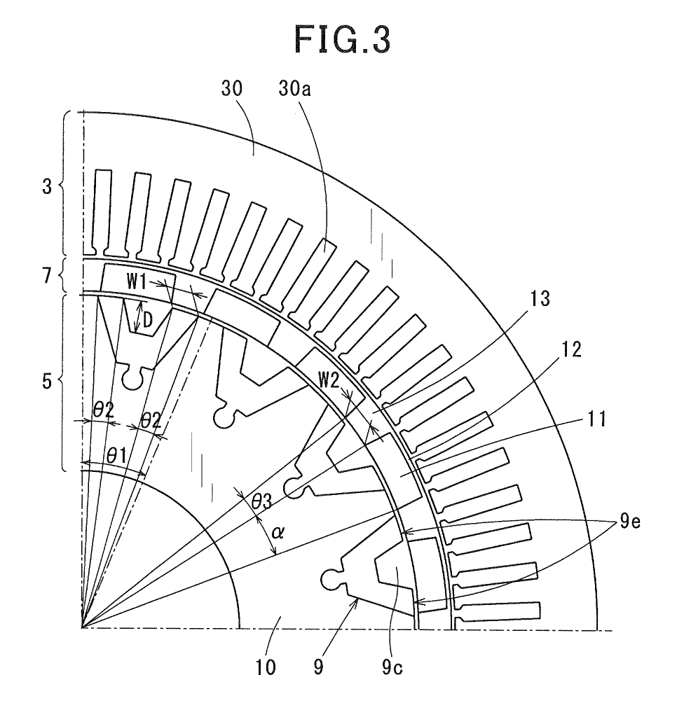

As shown in FIG. 3, the permanent magnets 11 have a pole arc angle α=12.5 degrees which, in the present embodiment, is defined by a center angle which is formed by: (i) a rotation center of the magnet rotor 7; and (ii) both circumferential ends of an inner diameter face of the permanent magnets 11 that faces the outer diameter face of the magnetic induction rotor 5 via the gap between the magnetic induction rotor 5 and the magnet rotor 7.

The permanent magnets 11 are circumferentially spaced at predetermined intervals and are annularly arranged. Each of permanent magnets 11 are radially magnetized. Each circumferentially adjacent two permanent magnets 11 are arranged in such a manner that they are different in polarity from each other, i.e., alternate between N and S poles.

As shown in FIG. 1, the soft magnetic material 12, which is ring-shaped, is located at a full circumference of the magnet rotor 7 in such a way as to cover an outer periphery (radially outside surface) of the 20 permanent magnets 11. Hereinafter, the soft magnetic material 12 is referred to as “ring-like soft magnetic material 12”.

As shown in FIG. 1, the soft magnetic material 13 is located between the circumferential adjacent two permanent magnets 11 (magnetic poles) in such a way as to form a magnetic flux penetration region. Hereinafter, the soft magnetic material 13 is referred to as “interpolar soft magnetic material 13”.

In other words, at the inner diameter side of the ring-like soft magnetic material 12, the 20 interpolar soft magnetic materials 13 are circumferentially arranged at regular intervals. The permanent magnets 11 are placed in an opening portion which is formed between the circumferential adjacent two interpolar soft magnetic materials 13.

The ring-like soft magnetic material 12 and the interpolar soft magnetic materials 13 is formed by, for example, laminating electromagnetic steel plates, but may be integrally or separately formed.

As shown in FIG. 3, the following relationship is satisfied:

W1≦W2

where W1 denotes a circumferential width of the magnetic flux entry and exit 9e projecting toward the outer diameter face of the magnetic induction rotor 5, and W2 denotes a circumferential distance between each circumferentially adjacent two permanent magnets 11, i.e., a circumferential width of the inner diameter face of the interpolar soft magnetic materials 13.

In other words, a center angle θ3=5.5 degrees with respect to the circumferential width W2 of the inner diameter face of the interpolar soft magnetic materials 13 is larger than a center angle θ2=4.5 degrees with respect to the circumferential width W1 of the magnetic flux entry and exit 9e.

As shown in FIG. 3, a maximum depth of the segment concave portion 9c formed in the segments 9, i.e., a depth D from the outer diameter face to the bottom face of the segment concave portion 9c is set to a size equal to or larger than the circumferential width W2 of the inner diameter face of the interpolar soft magnetic materials 13.

Next, operation of the motor 1 is described.

In the magnet rotor 7, the permanent magnets 11 are arranged in such a way as to alternate between N and S poles. Thus, this magnet rotor 7 provides the magnetic induction rotor 5 with a change of magnetomotive force having a frequency of 10ωn which is obtained as the product of (i) n=10 that is the number of pole pairs of the magnet rotor 7 and (ii) an angular velocity con of the magnet rotor 7.

In the magnetic induction rotor 5, the 16 segments 9 forming magnetic paths are formed into an approximate V-shape, and the apical face of the respective two segment arm sections 9a, as the magnetic flux entry and exit 9e, projects toward the outer diameter face of the magnetic induction rotor 5. This can produce a change of magnetic path having a frequency of 16ωk where ωk is an angular velocity of the magnetic induction rotor 5. Thus, the change of magnetomotive force of 10ωn is modulated as the change of magnetic path of frequency 16ωk.

Magnetic flux, which is transmitted from one permanent magnet 11, passes through one segment 9 from its one of the two magnetic flux entry and exit 9 which is an entry side. Subsequently, when the other of the two magnetic flux entry and exit 9, which is an exit side, faces another permanent magnet 11 having a reverse polarity with respect to one permanent magnet 11, the magnetic flux passes through another permanent magnet 11 from the other of the two magnetic flux entry and exit 9, which is the exit side, and then, propagates to the armature 3. On the other hand, when the other of the two magnetic flux entry and exit 9, which is the exit side, faces the interpolar soft magnetic material 13, the magnetic flux passes through the interpolar soft magnetic material 13 forming the magnetic flux penetration region, and then, propagates to the armature 3.

If all of the magnet rotor 7 facing the outer diameter side of the magnetic induction rotor 5 is covered by the permanent magnets 11, a component of the magnetic induction rotor 5 does not fully propagate to the armature 3. In the present embodiment, the interpolar soft magnetic material 13 is arranged between each circumferentially adjacent two permanent magnets 11 in such a way as to form the magnetic flux penetration region therebetween, thereby providing good magnetic modulation.

Here, a frequency of a magnetic change which propagates to the armature 3 is expressed as the sum and difference of 10ωn (change of magnetomotive force) and 16ωk (change of magnetic path) due to modulation action. Provided that ωm denotes an angular velocity of rotating magnetic field produced in the armature winding 31 (three-phase windings) with pole pairs of m=6, action of the inverter 8 is controlled so as to satisfy the following formula (1) with respect to ωm, and then, the armature winding 31 is energized.

6ωm=|10ωm±16ωk| (1)

Thus, the magnetic induction rotor 5, the magnet rotor 7, and the armature 3 can interact with one another for energy conversion. Due to this, they can function aas a magnetic modulation motor.

In the motor 1 as described above, the magnetic induction rotor 5 can be arranged at the most inner diameter side, not between the armature 3 and the magnet rotor 7. Thus, the 16 segments 9 forming the magnetic path can be integrally cast in high-strength aluminum material (for example, duralumin). This can achieve a rotary structure with high rigidity.

In addition, the magnetic induction rotor 5 is arranged at the most inner diameter side. This enables the magnetic induction rotor 5 to be easily fixed to the first rotary shaft 4. Therefore, in the magnetic induction rotor 5, the 16 segments 9 are supported by the rotor hub 10 in which the central hole 10a is formed. The first rotary shaft 4 can be fitted in this central hole 10a by press fit or the like. Thus, the magnetic induction rotor 5 can be tightly and easily fixed to the first rotary shaft 4.

Further, in the magnetic induction rotor 5, high-strength aluminum material with high electric conductivity is filled between the circumferential adjacent two segments 9. Thus, in dynamic magnetic field, an effect of reducing magnetic leakage (leakage flux) in this portion can be caused. As a result, magnetic modulation is orderly performed between the magnet rotor 7 and the magnetic induction rotor 5. This can further improve performance of the motor 1.

As described above, according to the first exemplary embodiment, a strength of centrifugal force resistance can improved, and the motor 1 can be downsized and upgraded. Such advantageous effects can be obtained. In addition, modulation action of a magnetic circuit can be well performed. This can further improve performance of the motor 1.

In the motor 1 described in the first exemplary embodiment, the circumferential width W1 of the magnetic flux entry and exit 9e of the respective segments 9 is set to be equal to or less than the circumferential width W2 of the inner diameter face of the interpolar soft magnetic materials 13 (W1≦W2).

Here, if W1 is larger than W2 (W1>W2), magnetic fields of the adjacent two permanent magnets 11 are short-circuited near the magnetic flux entry and exit 9e. Thus, magnetic flux does not effectively pass through the segments 9. This can cause significant leakage flux near the magnetic flux entry and exit 9e. Thus, magnetic force of the respective permanent magnets 11 may be weakened.

On the other hand, if the relationship (W1≦W2) as described above is satisfied, magnetic fields of the adjacent two permanent magnets 11 are not short-circuited near the magnetic flux entry and exit 9e. Therefore, magnetic force of the respective permanent magnets 11 cannot be weakened, which can provide good magnetic modulation for the segments 9.

Further, in the motor 1 described in the first exemplary embodiment, the depth D from the outer diameter face to the bottom face of the segment concave portion 9c is set to a size equal to or larger than the circumferential width W2 of the inner diameter face of the interpolar soft magnetic materials 13 (D≧W2) (see FIG. 3). This operation and effect are described below.

In each circumferentially adjacent two permanent magnets 11, their width and size are set so as to reduce interpolar leakage as described above. Here, in a part of the magnetic induction rotor 5 other than the segments 9, i.e., the segment concave portion 9c that is required to avoid occurrence of magnetic leakage, its depth D is set to a size equal to or larger than the circumferential width W2 of the inner diameter face of the interpolar soft magnetic materials 13. This can reduce magnetic leakage to an acceptable level. Such an effect can be obtained in the present embodiment.

Next, based on simulation results in magnetic field analysis, effects of the motor 1 are described compared to a motor in related art (hereinafter referred to as a “comparative motor”) in which the magnetic induction rotor 5 is arranged between the armature 3 and the magnet rotor 7.

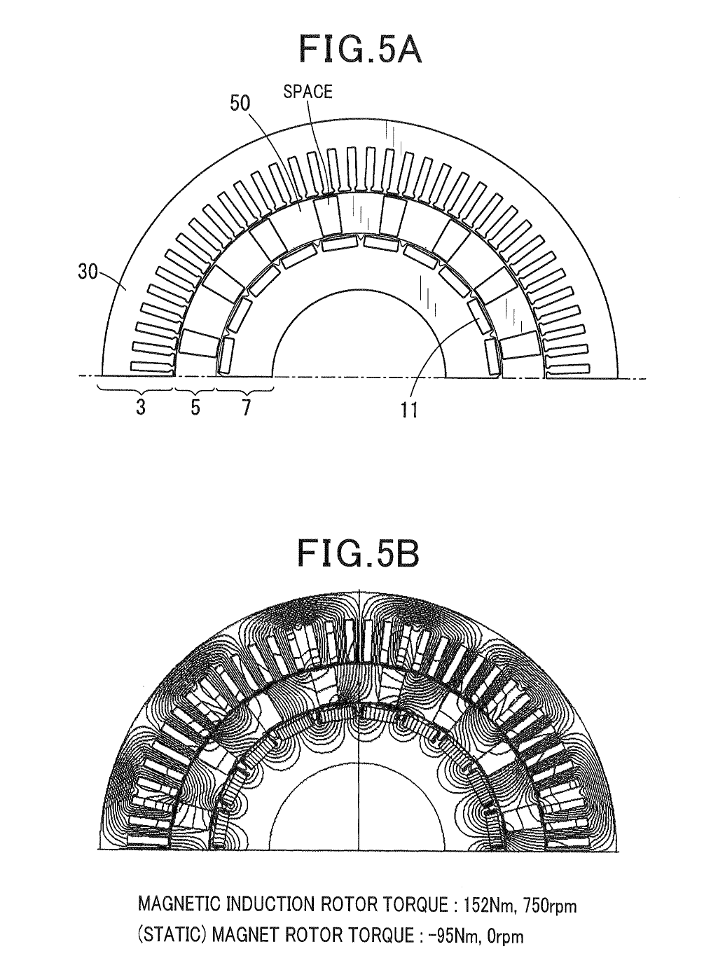

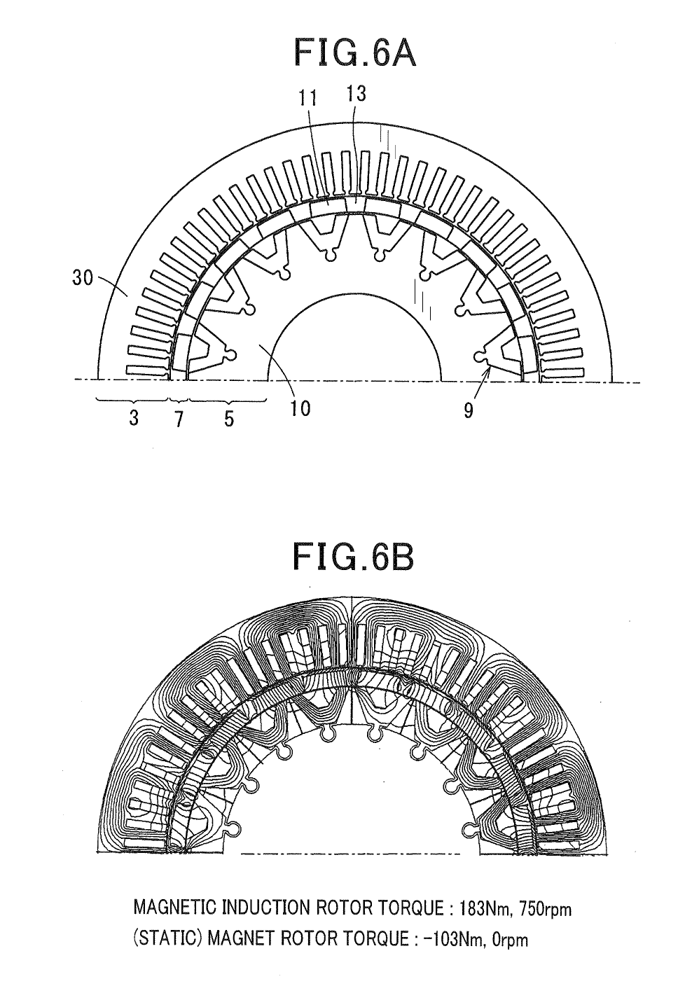

FIG. 5A is a configuration diagram showing an analysis model for the comparative motor, and FIG. 5B is an a analysis diagram showing a simulation result in magnetic field analysis for this analysis model of FIG. 5A. FIG. 6A is a configuration diagram showing an analysis model for the motor 1 according to the first exemplary embodiment, and FIG. 6B is an a analysis diagram showing a simulation result of a magnetic field analysis for this analysis model of FIG. 6A.

Here, the analysis model of the motor 1 is different from that of the comparative motor in arrangement of the magnetic induction rotor 5 and the magnet rotor 7. Both analysis models are the same outer diameter and axial length of the armature 3. For example, the outer diameter (□2) of the armature 3 is set to 54 mm (□2-54 mm) and the axial length of the armature 3 is set to 50 mm. In the magnetic induction rotor 5 of the comparative motor, a plurality of magnetic induction poles 50 are circumferentially arranged at regular intervals, and a space is formed between each two circumferential adjacent magnetic induction poles 50, which is not filled with aluminum material.

In the motor 1 and the comparative motor, under the condition that the magnet rotor 7 is static, the armature winding 31 is energized with three-phase alternating current (AC) of 170 A (effective value) to generate a rotary magnetic field, which rotates the magnetic induction rotor 5 at 750 rpm to generate torque. The generated torque is compared as follows.

The results show that the generated torque of the comparative motor is 152 Nm and the generated torque of the motor 1 is 183 Nm which is larger than that of the comparative motor.

Compared to simulation results in magnetic field analysis, as shown in FIG. 5B and FIG. 6B, similar magnetic modulation is performed in the comparative motor (see FIG. 5B) and the motor 1 (see FIG. 6B). There, even if a configuration of the motor 1 in which the magnet rotor 7 is arranged between the armature 3 and the magnetic induction rotor 5, the flow of magnetic flux is not blocked by the magnet rotor 7, and then magnetic flux passes through the interpolar soft magnetic materials 13 provided in the magnet rotor 7, which propagates from the magnetic induction rotor 5 to the armature 3. This prevents the generated torque from decreasing.

As described above, the magnetic induction rotor 5 is provided with the magnetic flux penetration region (interpolar soft magnetic materials 13) between the adjacent two permanent magnets 11 in such a way that all of the magnetic induction rotor 5 is not covered by the permanent magnets 11 arranged between the magnetic induction rotor 5 and the armature 3 when magnetic flux is transferred therebetween. Thus, in the motor 1, magnetic modulation action works, even if the magnet rotor 7 and the magnetic induction rotor 5 are reversely arranged. This can provide performance equivalent to or larger than that of the comparative motor in which the magnetic induction rotor 5 is arranged between the armature 3 and the magnet rotor 7.

In the configuration of the motor 1 according to the present exemplary embodiment, as described above, the magnetic induction rotor 5 is arranged at the most inner diameter side. This can improve mechanical rigidity of the magnetic induction rotor 5 and can improve centrifugal force resistance.

In the comparative motor in which the magnetic induction rotor 5 is arranged between the armature 3 and the magnet rotor 7, the obtained centrifugal force resistance is up to approximately 7000 rpm. In contrast, in the motor 1 described in the first exemplary embodiment, the obtained centrifugal force resistance is up to approximately 15000 rpm more than twice that of the comparative motor. Thus, the motor 1 can be downsized and upgraded more than twice compared to the comparative motor, which is able to produce advantageous effects compared to the comparative motor.

Next, a simulation of magnetic field analysis is performed by using four analysis models A, B, C and D with different configurations of the magnet rotor 7.

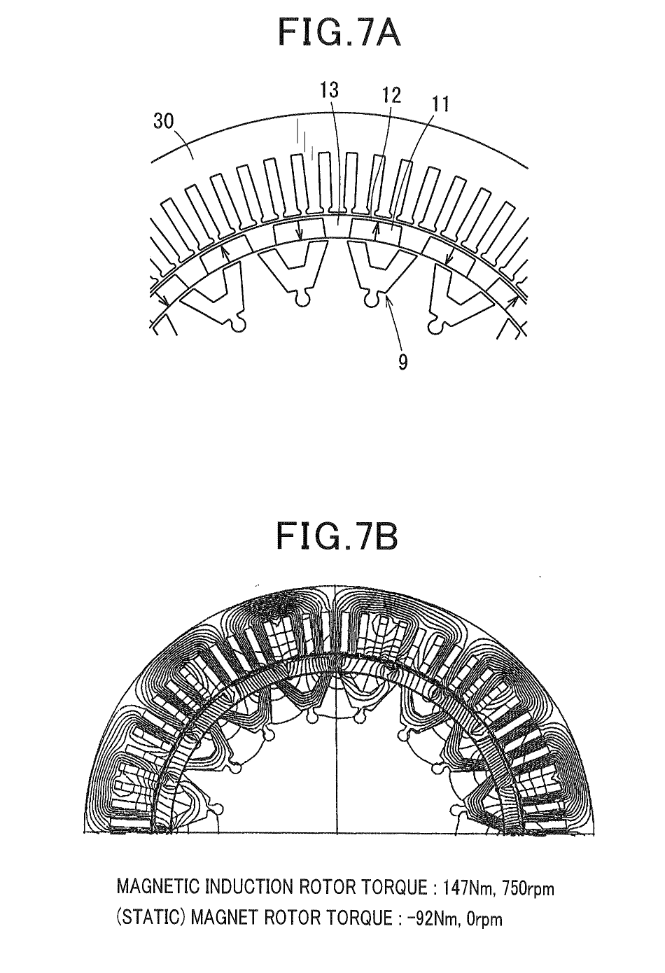

FIG. 7A shows the analysis model A with a configuration of the magnet rotor 7 including the ring-like soft magnetic material 12 and the interpolar soft magnetic materials 13 as described in the first exemplary embodiment.

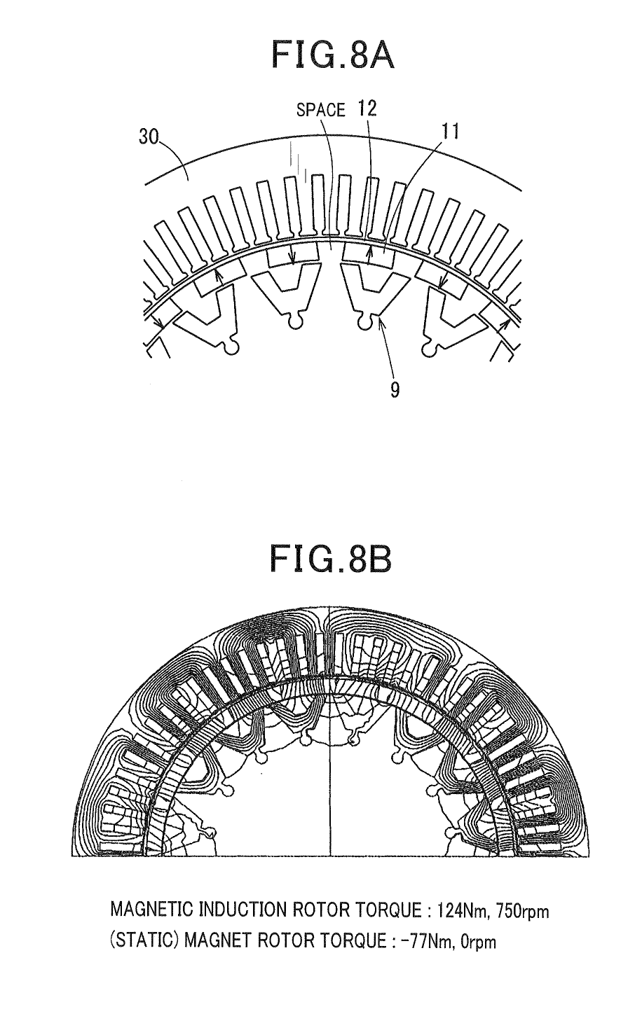

FIG. 8A shows the analysis model B with a configuration of the magnet rotor 7 in which the interpolar soft magnetic materials 13 are omitted and the outer periphery of the permanent magnets 11 is covered by the ring-like soft magnetic material 12.

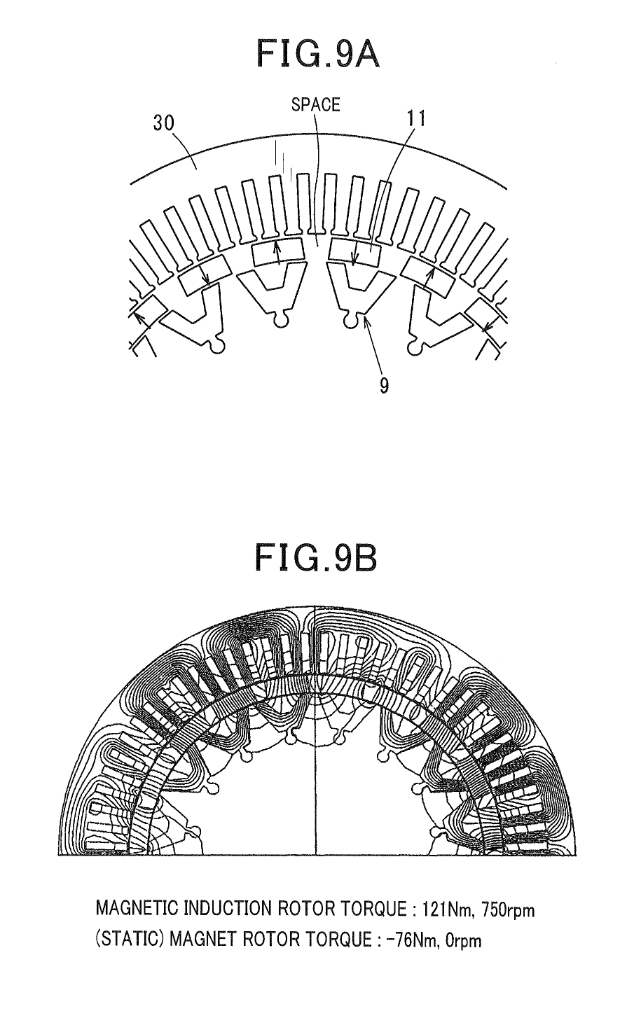

FIG. 9A shows the analysis model C with a configuration of the magnet rotor 7 in which both of the ring-like soft magnetic material 12 and the interpolar soft magnetic materials 13 are omitted.

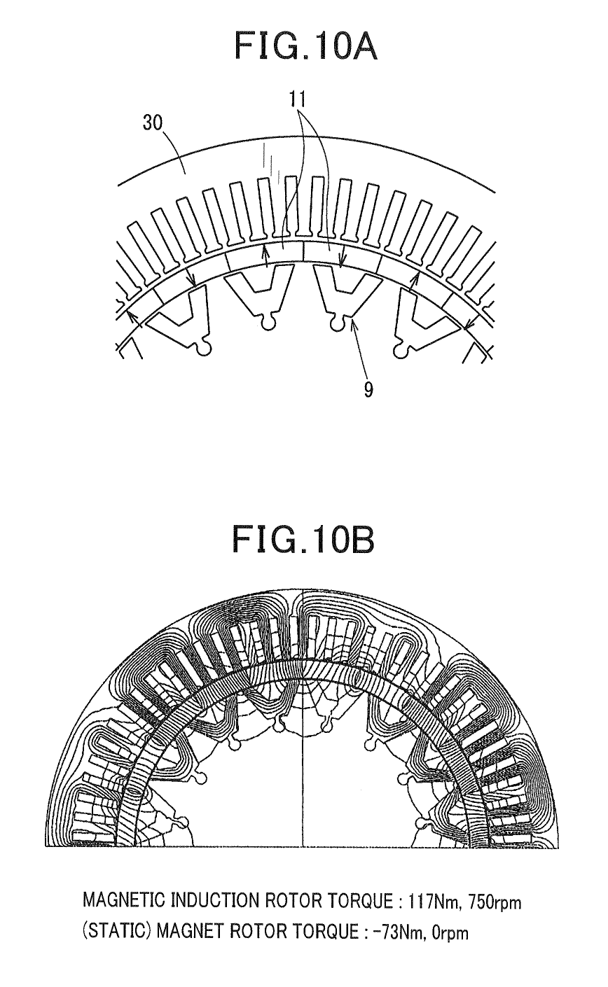

FIG. 10A shows the analysis model D with a configuration of the magnet rotor 7 in which both of the ring-like soft magnetic material 12 and the interpolar soft magnetic materials 13 are not used and there is no magnetic flux penetration portion, i.e., the permanent magnets 11 are circumferentially and tightly arranged with no space.

FIGS. 7B, 8B, 9B, and 10B are magnetic figures showing analysis results of the analysis models A, B, C, and D. In this analysis, the magnetic induction rotor 5 used in the respective analysis models A, B, C, and D has a configuration with only segments 9, and high-strength aluminum material described in the first exemplary embodiment is not filled. The reason is to expressly examine the effect of existence or non-existence of a space or magnetic material around magnets and effects of being covered by magnets.

In the four analysis models A, B, C, and D, the generated torques are compared. As a result, the analysis model A using the ring-like soft magnetic material 12 and the interpolar soft magnetic materials 13 has the best result of the generated torque which is 147 Nm. The generated torque is decreased in order of: (i) the analysis model B using only the ring-like soft magnetic material 12; (ii) the analysis model C forming the magnetic flux penetration region without using the soft magnetic material; and (iii) the analysis model D. As is clear from these results, the generated torque of the respective analysis models A, B, and C including the magnet rotor 7 provided with the magnetic flux penetration region are higher than that of the analysis D including the magnet rotor 7 in which the magnetic flux penetration region is not provided.

Next, the second to fifth exemplary embodiments are described below.

In these embodiments, an arrangement of the armature 3, the magnet rotor 7, and the magnetic induction rotor 5 is the same as the first exemplary embodiment, i.e., the magnetic induction rotor 7 is arranged at the most inner diameter side. In the components identical with or similar to those in the first exemplary embodiment are given the same reference numerals for the sake of omitting unnecessary explanation.

### Second Exemplary Embodiment

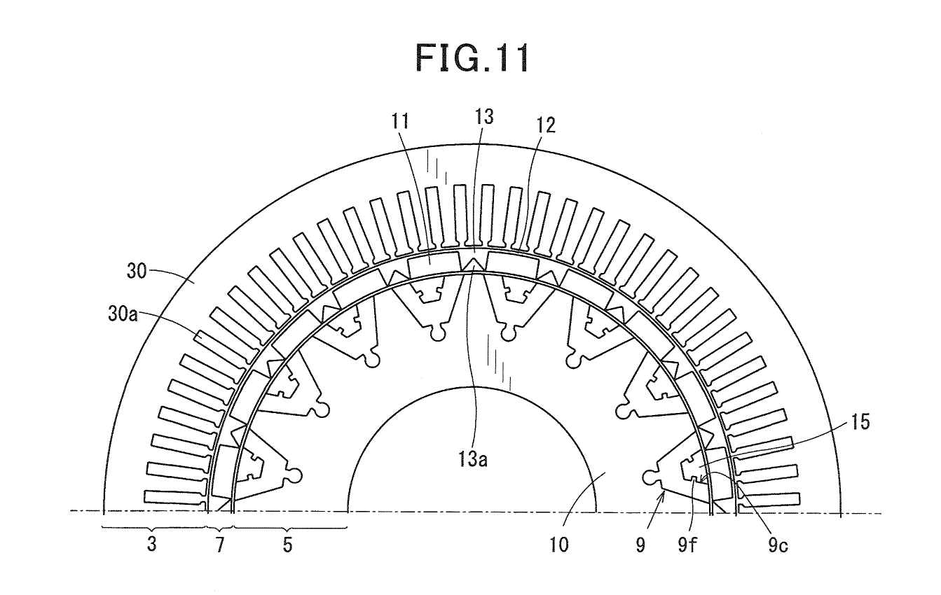

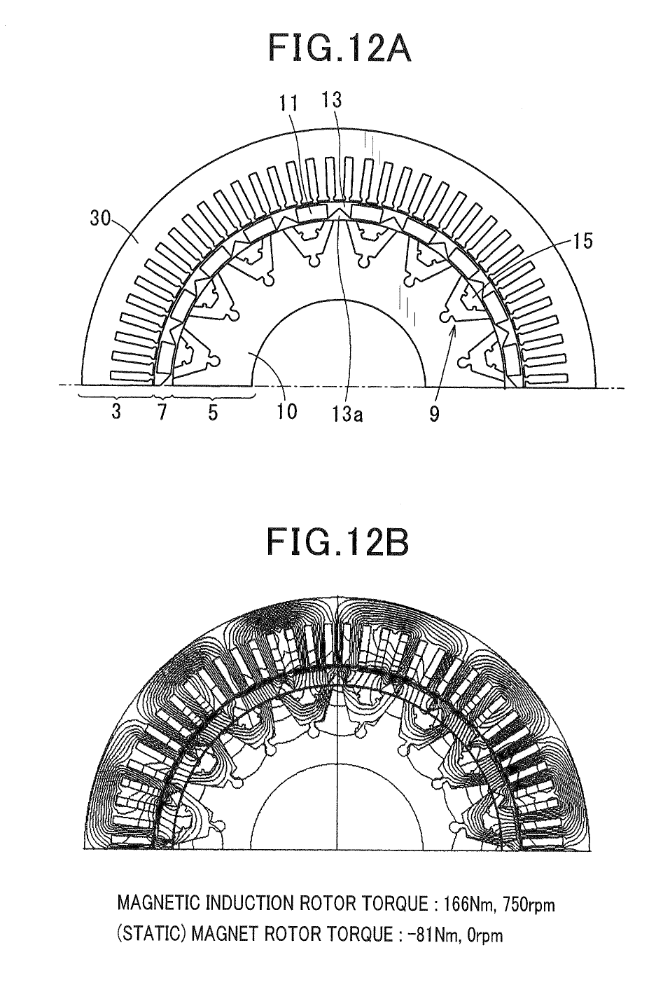

Referring to FIGS. 11, 12A and 12B, the second exemplary embodiment is described. In this embodiment, as shown in FIG. 11, a concave portion (recess or hollow portion) 13a is formed in the respective interpolar soft magnetic materials 13 of the magnetic induction rotor 5 described in the first exemplary embodiment.

As shown in FIG. 11, the concave portion 13a is formed in a surface of the respective interpolar soft magnetic materials 13 facing the magnetic induction rotor 5, i.e., an inner diameter face of the interpolar soft magnetic material 13 facing an outer diameter face of the magnetic induction rotor 5 via the gap between the magnet rotor 7 and the magnetic induction rotor 5. The concave portion 13a has a depth of approximately ⅔ of a thickness (i.e., a radial size) of the magnet rotor 7 and is formed into a taper shape in which an circumferential opening width is gradually widened from the deepest portion toward the inner diameter face of the magnet rotor 7.

The magnetic induction rotor 5 is configured by casting the 16 segments 9 in high-strength aluminum material as is the case in the first exemplary embodiment. In the second exemplary embodiment, the segment concave portion 9c is also filled with high-strength aluminum material 15. As shown in FIG. 11, this aluminum material 15 is retained (held) in the segment concave portion 9c by a retaining section (e.g., catch, locking, or holding section) 9f that is configured to project from a side surface of the segment arm section 9a.

Next, a magnetic field analysis of the motor 1 according to the second exemplary embodiment is also performed under the same condition as the first exemplary embodiment. FIG. 12A shows a model configuration diagram of an analysis model of the motor 1 according to the present embodiment, and FIG. 12B shows a simulation result of the magnetic field analysis for this analysis model.

The results show that the generated torque of the motor 1 is 166 Nm which is equivalent to or larger than that of the comparative motor shown in FIGS. 5A and 5B which is 152 Nm described in the first exemplary embodiment.

According to the present embodiment, the concave portion is formed in the inner diameter face of the respective interpolar soft magnetic materials 13, which is able to expect an effect of reducing leakage flux between surfaces of the adjacent two permanent magnets 11.

If the interpolar soft magnetic material 13, which is located between each circumferentially adjacent two permanent magnets 11, has a surface that is formed so as to be the same as magnetic pole surfaces of the adjacent two permanent magnets 11, leakage flux increases via the interpolar soft magnetic material 13. In contrast, the concave portion is formed in the inner diameter face of the respective interpolar soft magnetic materials 13, which is able to narrow and lengthen a path from which magnetic flux is leaked. This can prevent magnetic flux from being leaked, thereby providing good magnetic induction for the segments 9.

### Third Exemplary Embodiment

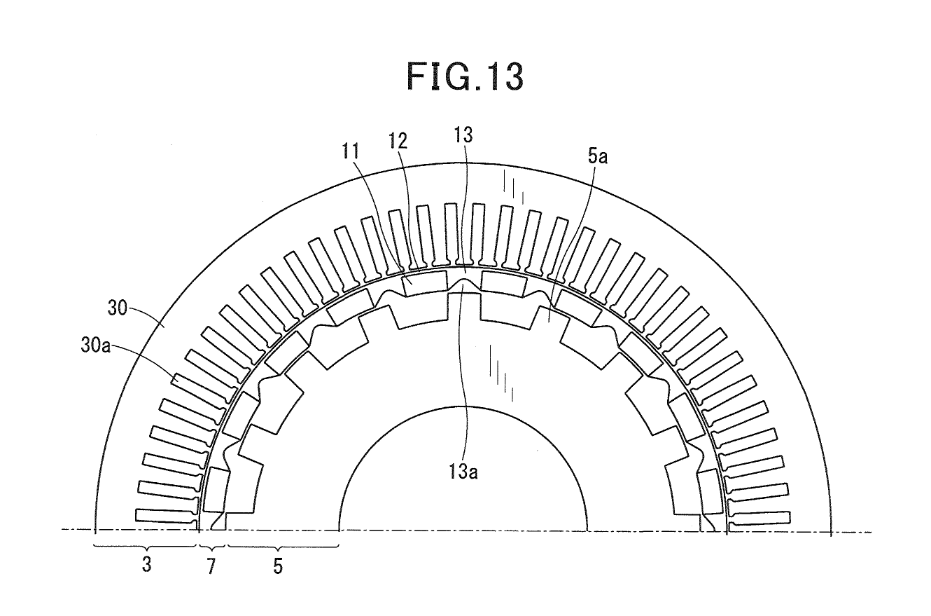

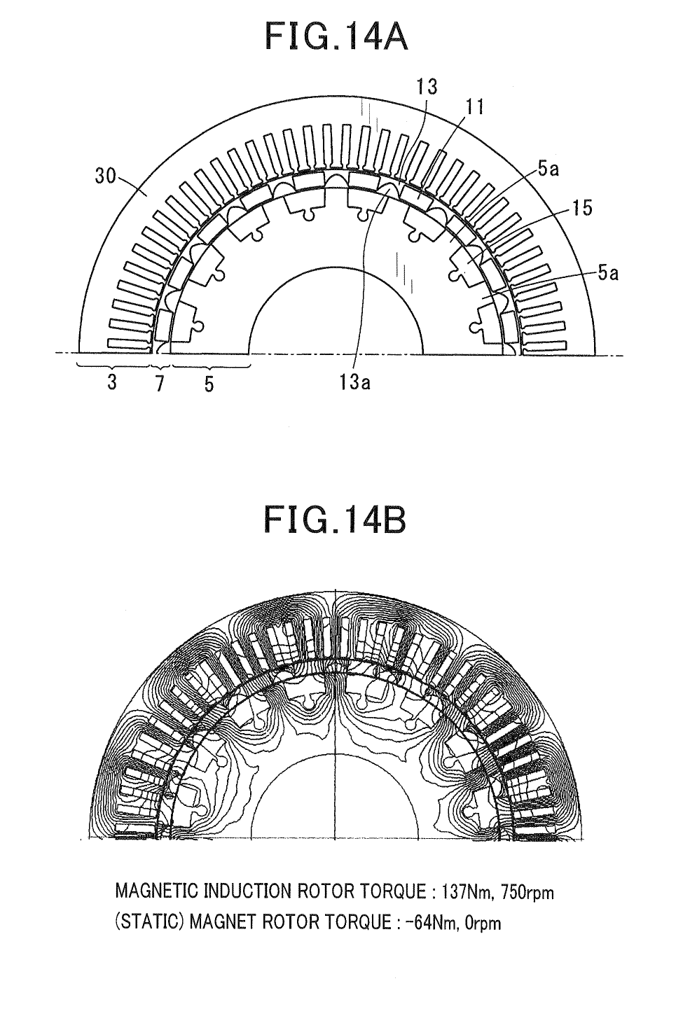

Referring to FIGS. 13, 14A and 14B, the third exemplary embodiment is described. In the present embodiment, the magnetic induction rotor 5 is formed into a gear shape.

As shown in FIG. 13, the magnetic induction rotor 5 is configured by laminating a plurality of electromagnetic steel plates which are cut out in the form of a gear shape, and includes k tooth-shaped portions 5a which radially project toward the outside, where k is the number of tooth-shaped portions 5a. The k tooth-shaped portions 5a are circumferentially arranged at regular intervals, which form an entry and exit of magnetic flux for the magnetic path.

Next, a magnetic field analysis of the motor 1 according to the third exemplary embodiment is also performed under the same condition as the first exemplary embodiment. FIG. 14A shows a model configuration diagram of an analysis model of the motor 1 according to the present embodiment, and FIG. 14B shows a simulation result of the magnetic field analysis for this analysis model. As shown in FIG. 14A, in the analysis model of the motor 1, aluminum material 14 is filled between the circumferential adjacent two tooth-shaped portions 5a.

The results show that the generated torque of the motor 1 is 137 Nm which is lower than that of the comparative motor, but there is no remarkable difference between the motor 1 and the comparative motor. In this case, the magnetic induction rotor 5 is formed into a gear shape, which allows this rotor 5 itself to also act as a rotor hub. In other words, the k tooth-shaped portions 5a are integrally formed of the same material as the rotor hub, which provides a strong structure with respect to centrifugal force and enables the magnetic induction rotor 5 to be very firmly fixed to the first rotary shaft 4. In addition, the motor 1 has high durability with respect to rotation vibration of the engine E1 or the like. Compared to the magnetic induction rotor 5 described in the first exemplary, the motor 1 has a potential for downsizing and lightening in view of high resistance to high speed use.

### Fourth Exemplary Embodiment

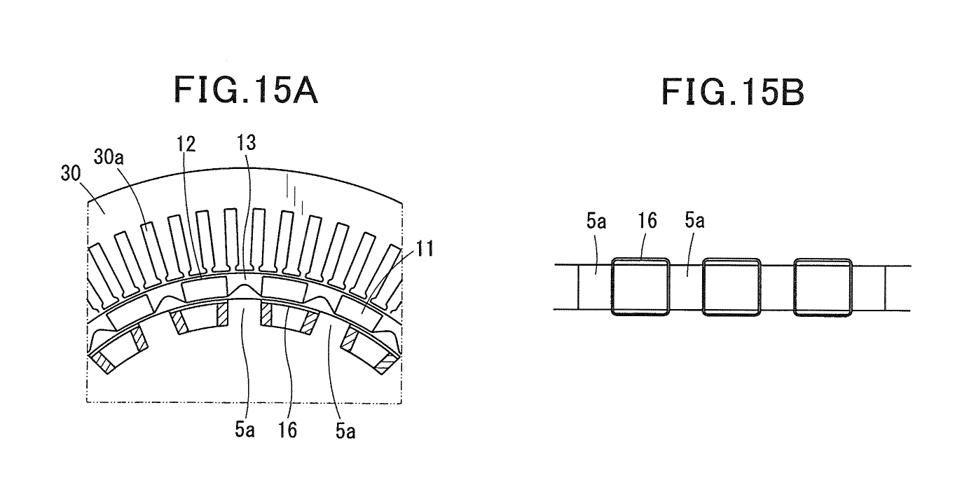

Referring to FIGS. 15A and 15B, the fourth exemplary embodiment is described. In the present embodiment, as shown in FIGS. 15A and 15B, with respect to the magnetic induction rotor 5 which is formed into a gear shape described in the third exemplary embodiment, a shorting coil 16 is provided between the circumferential adjacent two tooth-shaped portions 5a.

Here, in the motor 1 described in the first exemplary embodiment, high-strength aluminum material which forms the rotor hub 10 is filled between the circumferential adjacent two segments 9 (see FIG. 1). This can reduce magnetic leakage between the two segments 9.

As is the case with this, in the motor 1 of the present embodiment, the shorting coil 16 is located between the circumferential adjacent two tooth-shaped portions 5a, as shown in FIGS. 15A and 15B. This can also reduce dynamic magnetic leakage between the two tooth-shaped portions 5a, thereby being able to improve magnetic modulation action.

### Fifth Exemplary Embodiment

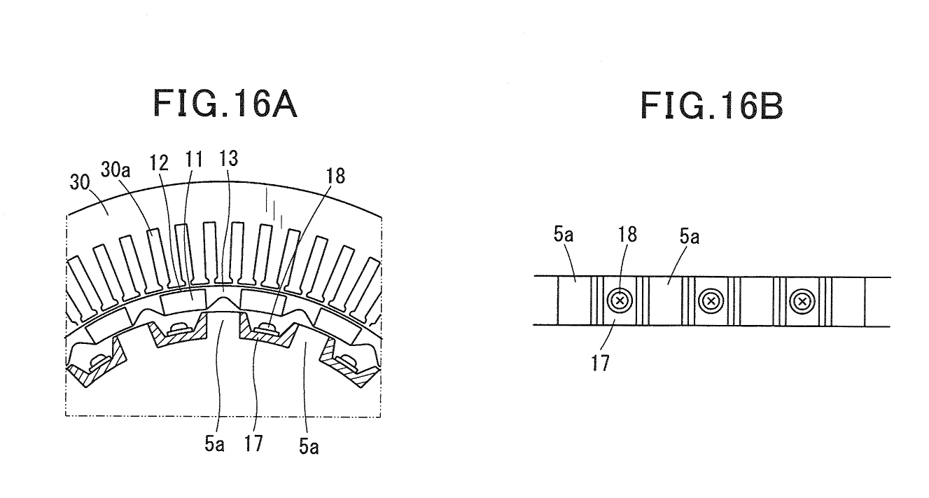

Referring to FIGS. 16A and 16B, the fifth exemplary embodiment is described. In the present embodiment, with respect to the magnetic induction rotor 5 formed in a gear shape described in the third exemplary embodiment, a copper plate 17 is provided between the circumferential adjacent two tooth-shaped portions 5a, as shown in FIGS. 16A and 16B. The copper plate 17 is fixed to the magnetic induction rotor 5 by a bolt 18 made of non-magnetic material.

As is the case with the fourth exemplary embodiment, a configuration of the fifth exemplary embodiment can also reduce dynamic magnetic leakage between the two tooth-shaped portions 5a, thereby being able to improve magnetic modulation action. In addition, the copper plate 17 can be easily mounted to the magnetic induction rotor 5, because it can be fixed by the bolt 18.

### (Modifications)

In the magnetic induction rotor 5 described in the first exemplary embodiment, the segment concave portion 9c is not filled with aluminum material, i.e., a space is formed in the segment concave portion 9c. However, in this motor 1, the segment concave portion 9c may be filled with aluminum material, as is the case with the second exemplary embodiment. In the case where the segment concave portion 9c is filled with aluminum material, in an axial end surface of the magnetic induction rotor 5, two aluminum materials, where one is aluminum material forming the rotor hub 10 and the other is aluminum material with which the segment concave portion 9c is filled, are configured so as not to cross the segments 9 and to magnetically connect with each other.

The magnetic induction rotor 5 described in the first exemplary embodiment is configured by a die-casting product which are integrally produced by casting the 16 segments 9 in high-strength aluminum material (e.g., duralumin), but need not be produced by die-casting. For example, this magnetic induction rotor 5 may be configured by annularly connecting the k segments 9 by use of a connecting member such as a stainless steel material (k is the number of segments 9). Alternatively, the magnetic induction rotor 5 may be configured by directly fixing the k segments 9 to the first rotary shaft 4 formed of a high-strength non-magnetic stainless steel material by welding or the like.

Next, the sixth to ninth exemplary embodiments are described below.

In these embodiments, the magnetic modulation motor as described above is applied to an electric transmission mounted in vehicles such as hybrid vehicles.

### Sixth Exemplary Embodiment

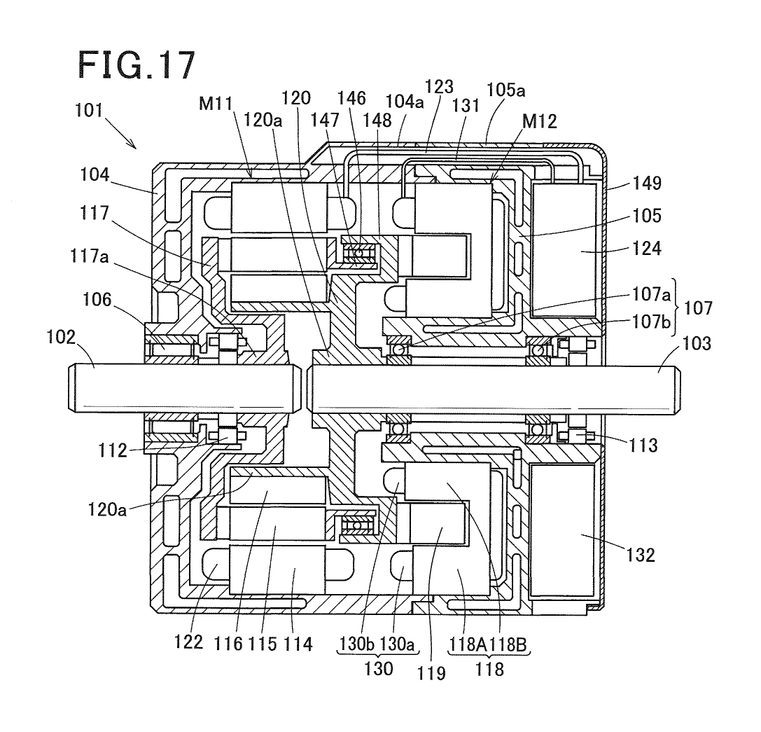

Referring to FIGS. 17 to 20, 21A, 21B, 22A, 22B, 23A, 23B, 24A and 24B, the sixth exemplary embodiment is described. In the present embodiment, an electric transmission using the magnetic modulation motor described above is applied to a hybrid vehicle.

As shown in FIG. 17, an electric transmission 101 according to the present embodiment includes: a first rotary machine M11 having a first rotary shaft 102; a second rotary machine M12 having a second rotary shaft 103; a front frame 104 mainly covering an outer periphery of the first rotary machine M11; and a rear frame 105 mainly covering an outer periphery of the second rotary machine M21.

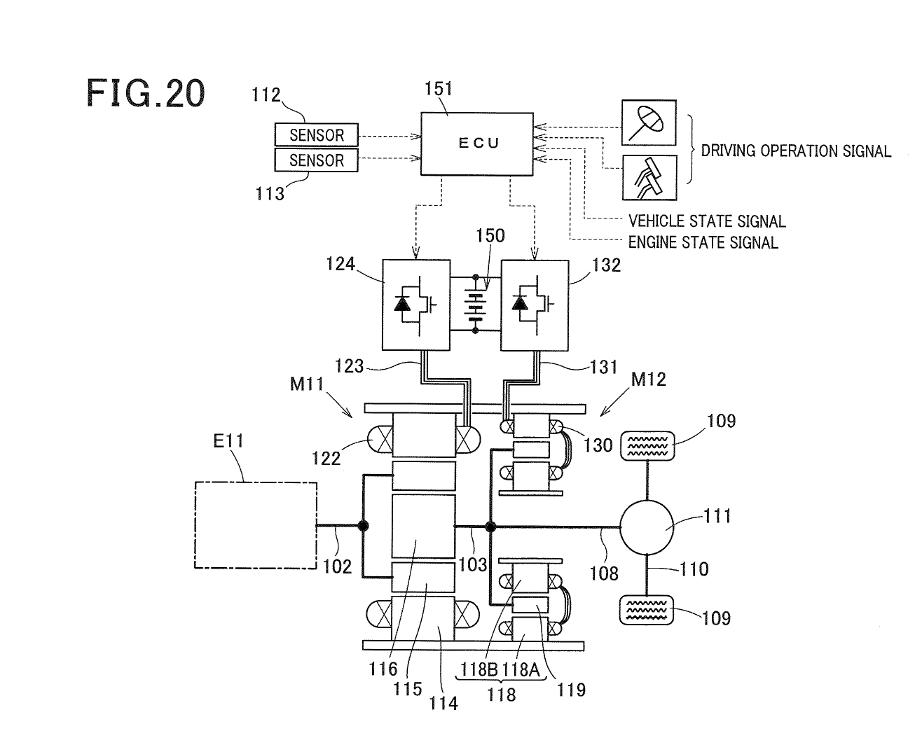

The first rotary shaft 102 is rotatably supported by the front frame 104 via an one-way clutch 106 also functioning as a bearing. This first rotary shaft 102 has an axial end portion which projects from the front frame 104 toward an axial outside (left side in FIG. 17). As shown in FIG. 20, this axial end portion is directly or indirectly connected to a crank shaft (not shown) of an engine E11.

The one-way clutch 106 is configured by, for example, a well-known roller type clutch and has a function for allowing the first rotary shaft 102 to rotate in only positive rotational direction of the engine E11 and for preventing it from rotating in the reverse rotational direction thereof.

The second rotary shaft 103 is arranged in such a manner that its shaft center is coincident with a shaft center of the first rotary shaft 102, and is rotatably supported by the rear frame 105 via two bearings 107. This second rotary shaft 103 has an a axial end portion which projects from the rear frame 105 toward an axial outside (right side in FIG. 17). As shown in FIG. 20, this axial end portion is directly or indirectly connected to a propeller shaft 108. This propeller shaft 108 is connected to a final stage reducer 111 with a differential mechanism for transferring a turning force (torque) to an axle 100 of a driving wheel 109.

In the front frame 104 and the first rotary shaft 102, a rotation angle sensor 112 is mounted. This rotation angle sensor 112 is configured by, for example, a resolver, and detects a rotation angle position of the first rotary shaft 102. In the rear frame 105 and the second rotary shaft 103, a rotation angle sensor 113 is mounted. This rotation angle sensor 113 is configured by, for example, a resolver, detects a rotation angle position of the second rotary shaft 103.

As shown in FIG. 17, the first rotary machine M11 includes: (i) an armature (hereinafter referred to as “first armature 114”) which is fixed to the front frame 104; (ii) a field element (hereinafter referred to as “a first field element 115”) which is rotatably arranged at an inner periphery side of this first armature 114 via a gap; and (iii) a magnetic modulation element 116 which is rotatably arranged at an inner periphery side of this first field element 115 via a gap. The first field element 115 is connected to the first rotary shaft 102 via a first rotor disc 117.

The first rotor disc 117 is made of a non-magnetic metal material (for example, aluminum material) and includes a cylindrical boss section 117a at its radial central portion. The cylindrical boss section 117a is fixed to an outer periphery of the first rotary shaft 102 by, for example, a serration fitting or a key coupling, and then, integrally rotates together with the first rotary shaft 102.

As shown in FIG. 17, the second rotary machine M12 includes: (i) an armature (hereinafter referred to as “second armature 118”) which is fixed to the rear frame 105; and (ii) a field element (hereinafter referred to as “second field element 119”) which is rotatably arranged relative to this second armature 118 via a gap. The second field element 119 is connected to the second rotary shaft 103 via a second rotor disc 120.

As is the case with the first rotor disc 117, the second rotor disc 120 is made of a non-magnetic metal material (for example, aluminum) and includes a cylindrical boss section 120a at its radial central portion. The cylindrical boss section 120a is fixed to an outer periphery of the second rotary shaft 103 by, for example, a serration fitting or a key coupling, and then, integrally rotates together with the second rotary shaft 103.

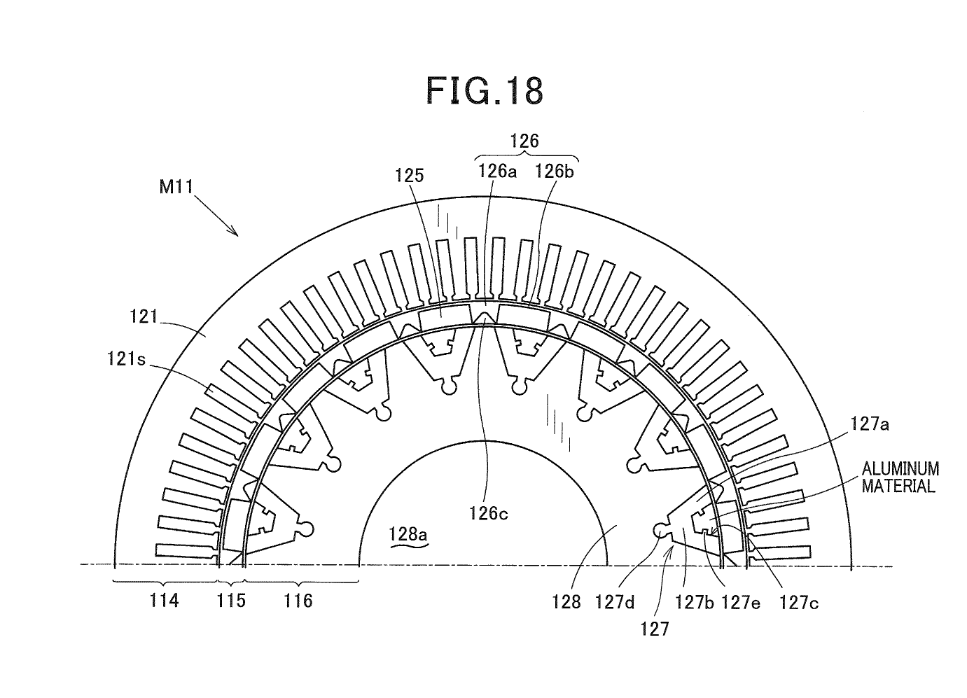

Next, referring to FIG. 18, a configuration of the first rotary machine M11 is described in detail. FIG. 18 is partial transverse cross-sectional view of the first rotary machine M11, which is perpendicular to a shaft center direction of the first rotary machine M11. In the FIG. 18, hatching showing the cross-section is omitted.

The configuration of the first rotary machine M11 is based on the magnetic modulation motor as described in the first to fifth exemplary embodiments, for example, the second exemplary embodiment as shown in FIG. 11.

### (Description of First Armature 114)

The first armature 114 includes an annular armature core 121 and an armature winding 122 (see FIGS. 17 and 20). In the armature core 121, a plurality of slots 121s (72 slots in the sixth exemplary embodiment) are circumferentially formed at regular pitches. The armature winding 122 is wound around the armature core 121 through the slots 121s.

The armature core 121 is configured by laminating a plurality of annular core sheets in which the slots 121s are formed by punching an electromagnetic steel plate.

The armature winding 122 is configured by a star connection of three-phase windings with m=6 pole pairs, and is connected to a well-known inverter 124 (see FIGS. 17 and 20) via three-phase harnesses 123.

### (Description of First Field Element 115)

The first field element 115 includes: 20 permanent magnets 125 (for example, neodymium magnets) forming poles with n=10 pole pairs; and a soft magnetic material 126 holding the 20 permanent magnets 125.

The 20 permanent magnets 125 are circumferentially arranged at regular intervals and are radially magnetized. Each circumferentially adjacent two poles (permanent magnets 125) are magnetized in such a way as to differ from each other in polarity.

The soft magnetic material 126 includes a plurality of interpolar soft magnetic materials 126a and a ring-like soft magnetic material 126b. Each of the interpolar soft magnetic materials 126a is located between each circumferentially adjacent two permanent magnets 125. The ring-like soft magnetic material 126b covers a first armature side surface of the permanent magnets 125, and is arranged in all circumferential surface of the first field element 115 facing the first armature 114.

The interpolar soft magnetic materials 126a and the ring-like soft magnetic material 126b are configured by laminating a plurality of soft magnetic material sheets which are formed into both shapes by punching press of an electromagnetic steel plate. The interpolar soft magnetic materials 126a and the ring-like soft magnetic material 126b are integrally provided in the present embodiment, but may be separately provided.

In each of the interpolar soft magnetic materials 126a, a concave portion (recess) 126c is formed at an inner diameter side facing the magnetic modulation element 116. The concave portion 126c has a depth of approximately ⅔ of a width between an inner diameter face and an outer diameter face (i.e., a size in a radial direction) of the first field element 115 and is formed into a taper shape in which an circumferential opening width is gradually widened from the deepest portion toward the inner diameter face of the first field element 115.

### (Description of Magnetic Modulation Element 116)

The magnetic modulation element 116 includes: 16 (m+n) segment magnetic poles (segments) 127 forming a path of magnetic flux; and a rotor hub 128 holding the 16 segment poles 127. As shown in FIG. 17, this magnetic modulation element 116 is supported by the second rotor disc 120 in such a manner that an outer periphery of a cylindrical support 120b integrated with the second rotor disc 120 is fitted in a circular hole 128a which opens an inner periphery of the rotor hub 128. Thus, the magnetic modulation element 116 is connected to the second rotary shaft 103 via the second rotor disc 120, and then, integrally rotates together with the second rotary shaft 103.

The segment poles 127 are configured by laminating a plurality of segment parts which are formed into an approximate V-shape (see a shape shown in FIG. 18) by punching an electromagnetic steel plate.

Hereinafter, two sides of the segment magnetic pole 127 which are opened into a V-shape are referred to “two segment arm sections 127a”. A base (root) side of the two segment arm sections 127a is referred to “segment base section 127b”. A recess (concave portion) formed between the two segment arm sections 127a is referred to “segment concave portion 127c”.

The 16 segment poles 127 are annularly arranged in a circumferential direction of the magnetic modulation element 116 at regular intervals. In such an arrangement of the segments 127, the two segment arm sections 127a are open into a V-shape radially outward, i.e., the segment base section 127b faces radially inside. In the present embodiment, a dovetail-shaped anchor section 127d is formed in the bottom face of the segment base section 127b. In the side surface of the respective segment arm sections 127a, a pair of locking parts 127e are provided in such a way as to project toward the segment concave portion 127c.

The rotor hub 128 is made of high-strength aluminum material (for example, duralumin) which is a non-magnetic and good electric conductor, and is produced by die-casting in which the 16 segment poles 127 are integrally cast. Thus, the anchor section 127d, provided in the segment base section 127b, is buried in aluminum material, and then, each of the segment poles 127 is tightly fixed to the rotor hub 128. In addition, the segment concave portion 127c is filled with the same aluminum material which is locked by the pair of locking parts 127e projecting from the side surface of the respective segment arm sections 127a. This prevents aluminum material from being detached from the segment concave portion 127c.

The 16 segment poles 127, held by the rotor hub 128, are magnetically separated from one another by aluminum material filled between the circumferentially adjacent two segment poles 127. Each of the 16 segment poles 127 is not fully filled in aluminum material. There, an apical face of the respective segment arm sections 127a exposes on the outer diameter face of the rotor hub 128, thereby forming an entry and exit of magnetic flux (magnetic flux entry and exit).

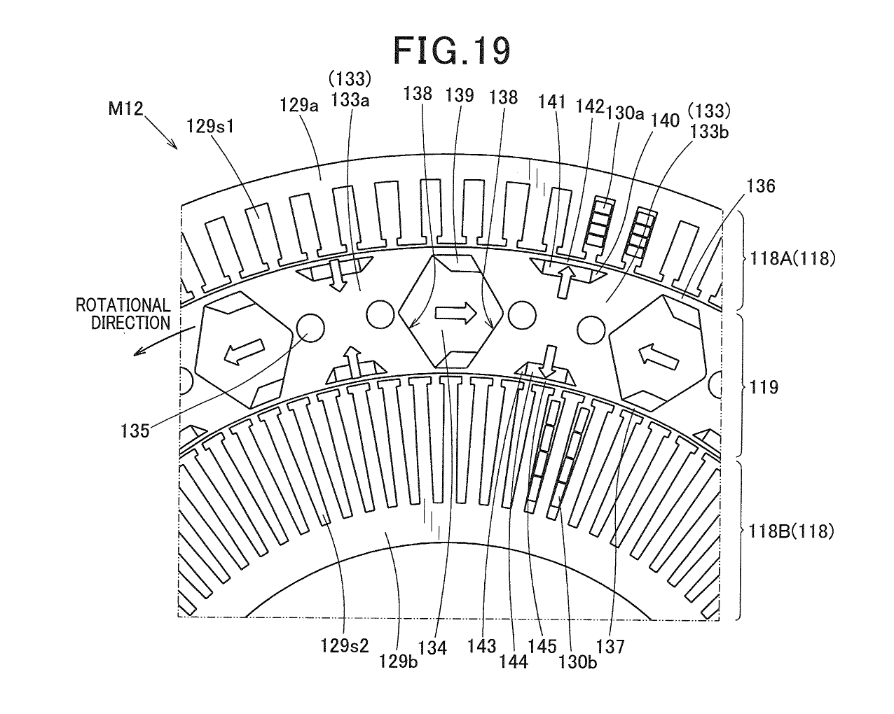

Next, referring to FIG. 19, a configuration of the second rotary machine M12 is described in detail. FIG. 19 is partial transverse cross-sectional view of the second rotary machine M12, which is perpendicular to a shaft center direction of the second rotary machine M12. In the FIG. 19, hatching showing the cross-section is omitted.

### (Description of Second Armature 118)

The second armature 118 includes: (i) an outer armature 118A located at the side of an outer periphery of the second field element 119; and (ii) an inner armature 118B located at the side of an inner periphery of the second field element 119. Both armatures 118A and 118B are integrally formed.

The outer and inner armatures 118A and 118B are configured by an armature core 129 (made of: (i) an outer armature core 129a of the outer armature 118A; and (ii) an inner armature core 129b of the inner armature 118B) and an armature winding 130 (see FIG. 17). In the armature core 129, a plurality of outer and inner slots 129s1 and 129s2 (e.g., 96 outer and inner slots in the present embodiment) are circumferentially formed at regular pitches. The armature winding 130 is wound around the armature core 129 though the outer and inner slots 129s1 and 129s2.

The armature core 129 is configured by laminating a plurality of annular core sheets in which the outer and inner slots 129s1 and 129s2 are formed by a punching press of an electromagnetic steel plate. As shown in FIG. 17, the outer and inner armature cores 129a and 129b are linked in the form of an approximately U-shaped cross section and integrally configured.

The armature winding 130 is configured by: (i) an outer armature winding 130a wound around the outer armature 118A; and (ii) an inner armature winding 130b wound around the inner armature 118B. Each of the outer and inner armature windings 130a and 130b is configured by a star connection of three-phase windings which are wounded in the form of a distributed winding with a predetermined winding pitch satisfying the following conditions: (i) the number of slots per pole per phase is q=2; and (ii) the number of poles is 16 (i.e., the number of pole pairs is 8).

The outer and inner armature windings 130a and 130b are connected in series to each other every phase winding of the three-phase windings, and are connected to an inverter 132 (see FIGS. 17 and 20) via three-phase harnesses 131.

The outer and inner armature windings 130a and 130b produce a winding magnetomotive force in such a manner that their poles, which are radially facing each other via the second field element 119, have the same polarity in the same circumferential position.

### (Description of Second Field Element 119)

The second field element 119 includes: (i) a plurality of segment magnetic poles 133 (16 segment magnetic poles 133 in the present embodiment) which are circumferentially arranged at regular intervals; and (ii) a plurality of permanent magnets (hereinafter referred to as “interpolar magnets 134”) which are located between the circumferential adjacent two segment magnetic poles 133. In the inner and outer surfaces of the respective segment magnetic poles 133, a magnetic field concave portion is formed as described below.

The 16 segment magnetic poles 133 are configured by laminating a plurality of annular segment sheets which are formed by punching an electromagnetic steel plate. For example, each of the 16 segment magnetic poles 133 are fastened to one another in a laminated direction by a fasting pin 135 made of soft magnetic material.

In the 16 segment magnetic poles 133, the circumferential adjacent two segment magnetic poles 133 are annularly and contiguously connected by an outer interpolar bridge 136 and an inner interpolar bridge 137. Specifically, in the circumferential adjacent two segment magnetic poles 133, the most outer diameter face and the most inner diameter face are annularly and contiguously connected.

Hereinafter, one of the circumferential adjacent two segment magnetic poles 133 is referred to as a “first segment magnetic pole 133a”, and the other is referred to as a “second segment magnetic pole 133b”. In the first and second segment magnetic poles 133a and 133b, their opposed faces circumferentially facing each other are referred to as “interpolar opposed faces 138”. Between the outer and inner interpolar bridges 136 and 137, an interpolar space is formed so as to open between the interpolar opposed faces 138 of the first and second segment magnetic poles 133a.

The interpolar magnets 134 are inserted in the interpolar space described above, and are magnetized in a circumferential direction indicated by arrows of FIG. 19. Specifically, the circumferential adjacent first and second segment magnetic poles 133a and 133b are magnetized in such a manner that their magnetic poles, which circumferentially face each other, differ from each other in polarity.

The interpolar magnets 134 are formed into such a shape that a radial width at the contact side of the second segment magnetic pole 133b is smaller than a radial width at the contact side of the first segment magnetic pole 133a, i.e., a so called arrowhead shape. Due to this, between the interpolar magnet 134 and the outer interpolar bridge 136 and between the interpolar magnet 134 and the inner interpolar bridges 137, a cavity portion 139 is formed at a rear side with respect to a rotational direction (counterclockwise direction indicated by arrows of FIG. 19) of the second field element 119.

In the circumferential central portion of the respective segment magnetic poles 133, an outer and inner magnetic field concave portions are formed at their radial outer and inner peripheries.

The outer magnetic field concave portion are formed by: (i) an outer slit 140 which is formed in the segment magnetic pole 133; and (ii) a permanent magnet (hereinafter referred to as an “outer pole center magnet 141”) which is inserted in the outer slit 140. The outer slit 140 is formed so as to be close to the most outer diameter side of the segment magnetic pole 133. The outer diameter side of the outer slit 140 is closed by an outer pole center bridge 142. The outer pole center magnet 141 is inserted in the outer slit 140, and is magnetized in a radial direction indicated by arrows in FIG. 19. Specifically, the circumferential adjacent outer pole center magnets 141 are magnetized in such a way as to differ from each other in polarity.

The inner magnetic field concave portion are formed by: (i) an inner slit 143 which is formed in the segment magnetic pole 133; and (ii) a permanent magnet (hereinafter referred to as an “inner pole center magnet 144”) which is inserted in the inner slit 143. The inner slit 143 is formed in such a way as to be close to the most inner diameter side of the segment magnetic pole 133. The inner diameter side of the inner slit 143 is closed by an inner pole center bridge 145. The inner pole center magnet 144 is inserted in the inner slit 143, and is magnetized in a radial direction indicated by arrows of FIG. 19. Specifically, the circumferential adjacent inner pole center magnets 144 are magnetized in such a way as to differ from each other in polarity. The outer and inner pole center magnets 141 and 144 are magnetized in such a manner that their magnetic poles, which radially face each other, have the same polarity.

Next, referring to FIG. 17, features related to an overall configuration of the electric transmission 101 are described below. In the following explanation, a left side of an axial direction (left-right direction shown in FIG. 17) is referred to as a “front side”, and a right side of the axial direction is referred to as a “rear side”.

In the first and second rotary machines M11 and M12, the magnetic modulation element 116 of the first rotary machine M11 and the second field element 119 of the second rotary machine M12 are mechanically coupled to each other via the second rotor disc 120. The magnetic modulation element 116 and the second field element 119 are configured so as to integrally rotate with the second rotary shaft 103.

The first and second rotary shafts 102 and 103 are located in such a manner that an opposite central position between first and second rotary shafts 102 and 103 axially facing each other via a gap is displaced to the front side. In other words, the opposite central position between the first and second rotary shafts 102 and 103 is shifted toward the front side from an axially intermediate position (hereinafter referred to as an “axially central position”) between the first and second rotary machines M11 and M12. In the case of FIG. 17, a front side end surface of the second rotary shaft 102 extends beyond the axially central position, and then reaches up to the inner periphery side of the first rotary machine M11.

Thus, the second rotor disc 120 can allow the cylindrical boss section 120a, which is fitted in the second rotary shaft 103, to be located at a position (axially central position) between the first and second rotary machines M11 and M12.

In addition, (i) the first field element 115 of the first rotary machine M11 and (ii) two rotors (the magnetic modulation element 116 and the second field element 119) connected to each other via the second rotor disc 120, are supported in a relatively rotatable manner via a bearing 146 which is located at approximately axially intermediate position (axially central position) between both two rotors. Specifically, the first field element 115 is provided with an annular inner support section 147 at the axial rear side (right side of FIG. 17). The second rotor disc 120 is integrally provided with an annular outer support section 148. The inner and outer support sections 147 and 148 are located so as to axially wrap. The bearing 146 described above is located between the inner and outer support sections 147 and 148. Though this bearing 146, the first field element 115 of the first rotary machine M11 and the two rotors (the magnetic modulation element 116 and the second field element 119) connected to each other are supported in a relatively rotatable manner.

In the present embodiment, the first field element 115 may be provided with the outer support section 148, and the second rotor disc 120 may be provided with the inner support section 147.

The two bearings 107, which support the second rotary shaft 103 with respect to the rear frame 105, are spaced at a predetermined distance. Hereinafter, one of the two bearings 107 which is located at the front side (left side of FIG. 17) is referred to as a “first rear bearing 107a”, and the other which is located at the rear side (right side of FIG. 17) is referred to as a “second rear bearing 107b”. The first rear bearing 107a is located in such a way as to be close to the axially central position at the inner diameter side away from the bearing 146 described above. Specifically, the first rear bearing 107a is located adjacent to the rear side of the cylindrical boss section 117a of the second rotor disc 120 in which the second rotary shaft is fitted.

The front and rear frames 104 and 105 are combined by an axial spigot-joint of their opening portions. Inside the front and rear frames 104 and 105, the first and second rotary machines M11 and M12 are integrally contained. Outside (anti-front side) the rear frame 105, a mounting space capable of mounting the inverters 124 and 132 described above is ensured.

The inverter 124 is mounted in the mounting space described above, and is connected to the armature winding 122 of the first armature 114 via the three-phase harnesses 123. The inverter 132 is mounted in the mounting space described above, and is connected to the armature winding 130 of the second armature 118 via the three-phase harnesses 131.

The front frame 104 is provided with a harness protector 104a that protects the three-phase harnesses 123 which are externally extracted from the front frame 104. The rear frame 105 is provided with a harness protector 105a that protects the three-phase harnesses 131 which are externally extracted from the rear frame 105.

In the final end (right end of FIG. 17) of the rear frame 105, a rear cover 149 is assembled. The rear cover 149 covers a rear side end surface of the inverters 124 and 132 mounted in the mounting space described above, and closes the opening side of this mounting space.

As shown in FIG. 20, the inverters 124 and 132 have DC (direct current) terminals which are connected to a vehicle battery 150 which is a DC power supply, and are activated upon reception of control signals from a powertrain integrated ECU (electronic control unit) 151.

As shown in FIG. 20, the powertrain integrated ECU 151 receives information, for example, (a) a vehicle state signal including a steering angle signal, an acceleration position signal, a brake signal, a shift position signal, (b) an engine state signal for informing engine state such as start and stop of the engine E11, and (c) a detected signal of the respective rotation angle sensors 112 and 113. And then, based on these information, the ECU 151 controls operation of the respective invertors 124 and 132.

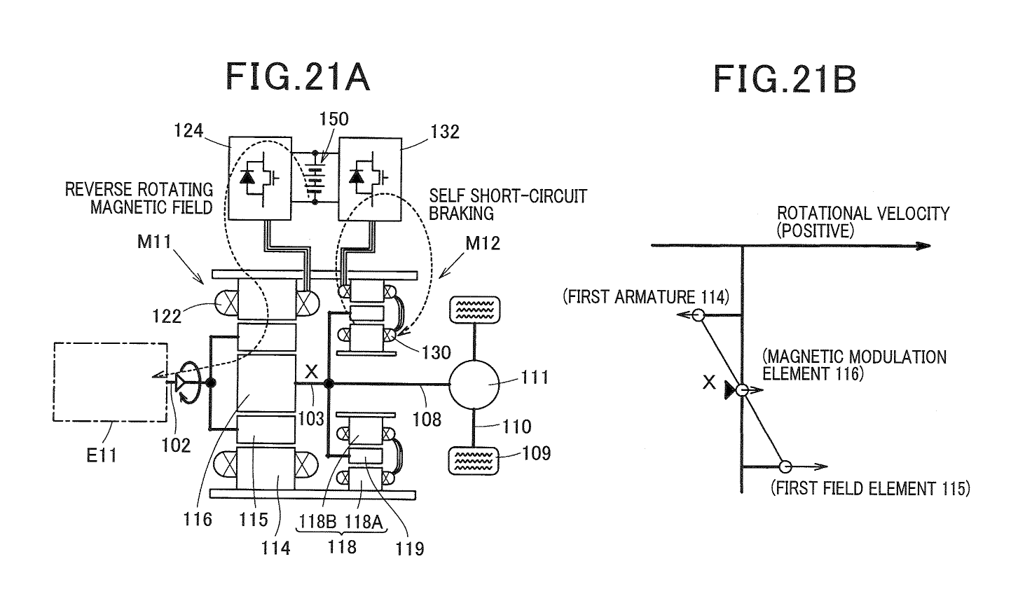

Next, referring to FIGS. 21A, 21B, 22A, 22B, 23A, 23B, 24A and 24B, operation of the electric transmission 101 is described.

### a) Engine Start Mode

In an engine start mode, the engine E11 is started. This operation is described with reference to FIGS. 21A and 21B.

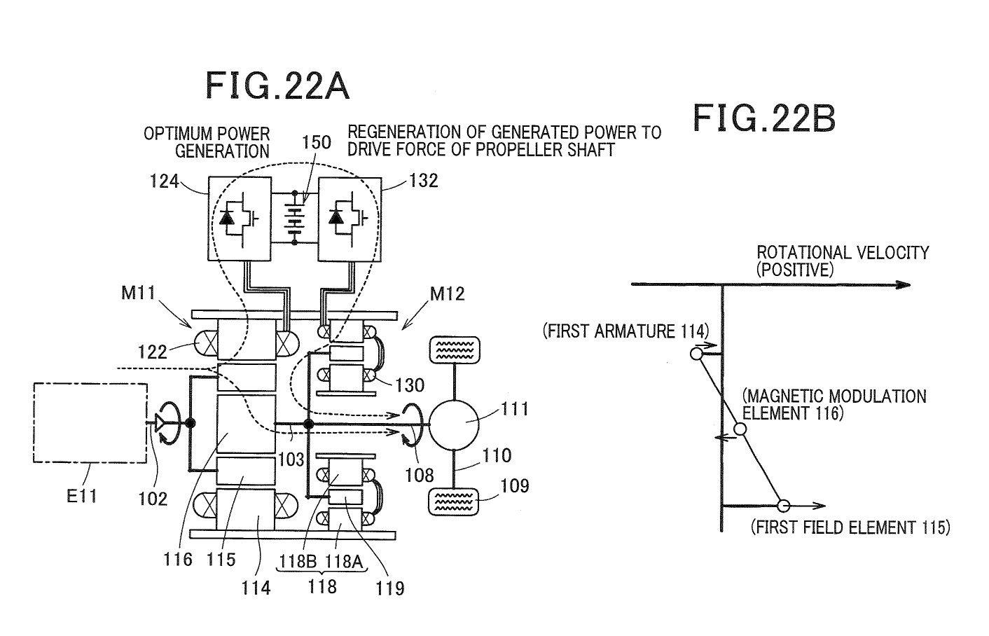

First, the first field element 114, which is connected to the first rotary shaft 102, is static, i.e., the engine E11 is stopped. Under this condition, as shown in FIG. 21A, a rotating magnetic field directed to an opposite direction of a rotational direction of the engine E11 is generated in the armature winding 122 of the first armature 114. Then, the magnetic modulation element 116 of the first rotary machine M11 tries to rotate in the opposite direction (the same direction as the rotating magnetic field). At this time, when the operation of the inverter 132 is controlled so as to short-circuit the armature winding 130 of the second armature 118, the second field element 119 of the second rotary machine M12 is braked. This restricts a reverse rotation of the magnetic modulation element 116 connected to this the second field element 119 (see a sign “x” shown in FIGS. 22A and 22B). Along with this, a torque directed to a positive rotational direction as shown in arrows of FIG. 22B, i.e., the rotational direction of the engine E11 is generated in the first field element 115 of the first rotary machine M11, and then, the engine E11 is started. In this way, the second rotary machine M12 also assists the engine E 11 to start.

### b) Engine Acceleration and Axle Activation Mode

In an engine acceleration and axle activation mode, the engine E11 is accelerated to activate an axle side, thereby starting and accelerating the vehicle. This operation is described with reference to FIGS. 22A and 22B.

In this operation, as an engine speed is increased, a rotational velocity of the first field element 115 is increased. Subsequently, the magnetic modulation element 116, which is connected to the second rotary shaft 103 located at the axle side, receives reaction force due to vehicle inertial resistance or the like. Thus, the rotating magnetic field of the first armature 114 is directed to a reverse rotation, as shown in FIG. 22A. In this state, the first armature 114 generates electric power to provide its reaction force. Then, the magnetic modulation element 116 receives rotational torque due to the reaction force of power generation and the drive force of the engine E11, and increases the rotational velocity, as shown in FIG. 22A. In addition, the AC power generated by the first rotary machine M11 is transferred to the inverter 132 for driving the second rotary machine M12. Thus, the second rotary machine M12 receives the AC power supplied from the inverter 132, and electrically drives the second field element 119.

In this way, the second rotary shaft 103 receives the power generation reaction force and the engine drive force via the magnetic modulation element 116, and also receives the electric drive force via the second field element 119 by using the power generated by the first rotary machine M11 to drive the second rotary machine M12 thorough the inverter 132. There, the second rotary shaft 103 is driven by three types of torque. In the engine acceleration and axle activation mode, the second rotary machine M12 can regenerate drive force of the propeller shaft 108 from the power generated by the first rotary machine M 11, as shown in FIG. 22A. This can achieve a function of the electric transmission that efficiently performs torque and velocity conversion that converts the engine power to the drive force of the propeller shaft 108, without using the power of the vehicle battery 150.

When the engine speed reaches a predetermined high engine speed, the magnetic modulation element 116 cannot be started by the power generation reaction force. In this case, it is possible to increase a rotation of the magnetic modulation element 116, i.e., a rotation of the second rotary shaft 103 by energizing the first armature 114 to generate torque (electric drive power). This consumes the power from the battery 150 and results in a vehicle driving method similar to an EV (electric vehicle).

### c) EV Drive Mode

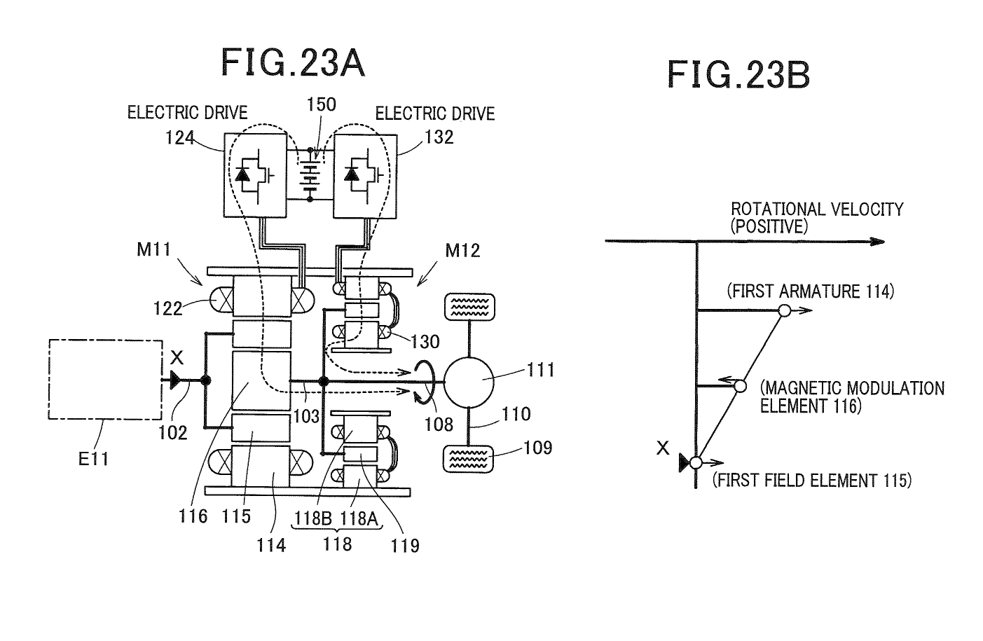

In an EV drive mode, the engine E11 is stopped, and the vehicle is driven by only the motor. This operation is described with reference to FIGS. 23A and 23B.

The first rotary machine M11 is accelerated by supplying the first armature 114 with electric power while receiving a rotational resistance of the magnetic modulation element 116 which is connected to the second rotary shaft 103 located at the axle side. Then, a torque, which tries to reversely rotate, acts on the first field element 115 connected to the first rotary machine 102. At this time, as shown in FIGS. 23A and 23B, the one-way clutch 106 prevents the first field element 115 from reversely rotating, and then, its magnetic torque reaction force is produced in the magnetic modulation element 116. There, an axle drive torque is produced.

In this way, due to the presence of the one-way clutch 106 that prevents the reverse rotation of the first rotary shaft 102, the first rotary machine M11 can also electrically operate as well as the second rotary machine M12, as shown in FIG. 23B. This can downsize the first rotary machine M11 as well as the second rotary machine M12.

### d) Vehicle Regenerative Control Mode

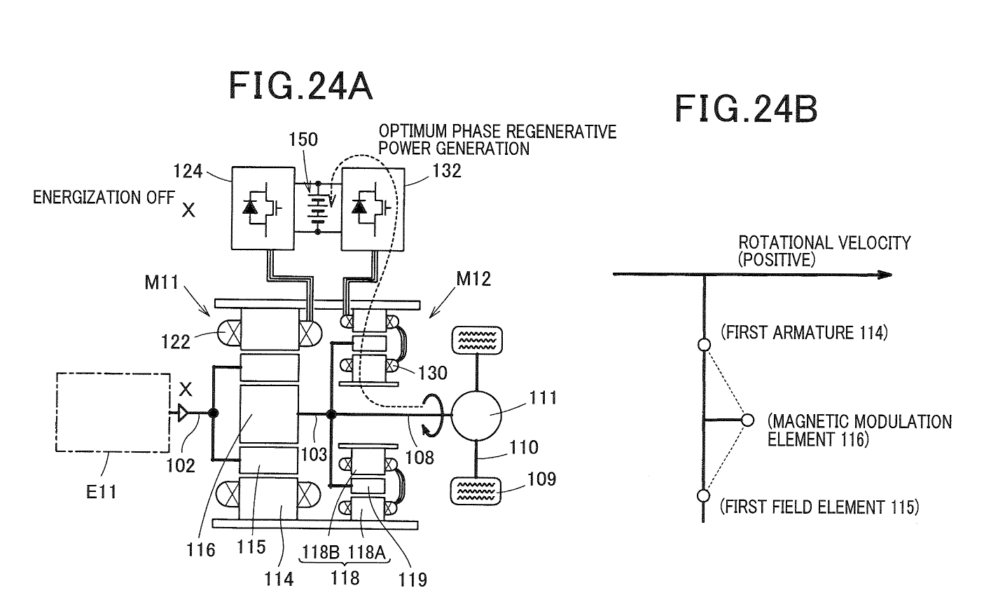

In a vehicle regenerative control mode, the running vehicle is decelerated and a regenerative braking is produced. This operation is described with reference to FIGS. 24A and 24B.

In this mode, in order to efficiently charge the vehicle battery 150 with braking energy as much as possible, the operation of the inverter 124 is stopped and the energization of the first armature 114 is turned off (as shown in a sign “X” of FIGS. 24A and 24B). Then, as shown in FIG. 24B, a rotation of the axle causes a rotation of the magnetic modulation element 116, but the magnetic connection with the first magnetic element 115 is discontinued, thereby preventing the braking energy from being given to a rotation or the engine E11. Thus, when the regenerative braking works, the first rotary machine M11 can function as a power cutoff clutch. As a result, the vehicle battery 150 can be efficiently charged with regenerative braking energy, as shown in FIG. 24B.

### (Effects of Sixth Exemplary Embodiment)

According to the first rotary machine M11 of the sixth exemplary embodiment, the magnetic modulation element 116 is not located between the first armature 114 and the first field element 115, and can be located at the opposite side (the most inner diameter side of the first rotary machine M11 in the present embodiment) of the first armature 114 with respect to the first field element 115. Thus, magnetic flux passing though the magnetic modulation element 116 forms a flow that U-turns around the segment poles 127 formed into the approximate V-shape, without interlinkage with the rotor hub 128 holding the segment poles 127. This causes no generation of large loop eddy current, even if the 16 segment poles 127 are casted in high-strength aluminum material. In other words, the 16 segment poles 127 can be reliably and easily supported and fixed by the high-strength aluminum material. This makes it possible to improve mechanical rigidity of the magnetic modulation element 116, which can improve vibration resistance and centrifugal force resistance of the magnetic modulation element 116. This enables the magnetic modulation element 116 to be tailored to high rotation and high torque specification.

In the two rotors (the first field element 115 and the magnetic modulation element 116) of the first rotary machine M11 and the second field element 119 which is the rotor of the second rotary machine M12, two rotor (the magnetic modulation element 116 and the second field element 119), which are connected to each other, and the first field element 115 are supported in a relatively rotatable manner via the bearing 146 which is inserted between (i) the inner support section 147 located at the axial rear side of the first field element 115 and (ii) the outer support section 148 provided in the second rotor disc 120. The second rotor disc 120 extends toward the inner diameter side from the bearing 146, and is fixed in such a manner that the cylindrical boss section 117a, which is located at its radially central portion, is fitted in the outer periphery of the second rotary shaft 103.

The second rotary shaft 103 is rotatably supported by the rear frame 107 via the two bearings 107 (the first rear bearing 107a and the second rear bearing 107b) axially spaced at a predetermined axial distance. Specifically, the first rear bearing 107a is located adjacent to the rear side of the cylindrical boss section 117a of the second rotor disc 120 in which the second rotary shaft 103 is fitted. This can improve rigidity of the magnetic modulation element 116 and the second field element 119, thereby being able to provide a durable structure.

The first field element 115 of the rotary machine M11 has (i) an axial front side which is connected to the first rotary shaft 102 via the first rotor disc 117, and (ii) an axial rear which is supported by the second rotor disc 120 via the bearing 146 described above. Therefore, both axial ends of the first field element 115 are supported. Such a structure of the first field element 115 are referred to as a “both ends supported structure”. This structure can improve also vibration resistance of the first field element 115.

Thus, it is possible to improve accuracy of the shaft center of the electric transmission 101 in which the first and second rotary machines M11 and M12 are integrally provided, and to improve durability thereof, thereby being able to respond to high speed.

Further, a body of the first and second rotary machines M11 and M12 used for the electric transmission 101 of the sixth exemplary embodiment is determined by a condition that can supply an output necessary for the EV drive mode in which the engine E11 does not operate and the vehicle is driven by only the vehicle battery 150. In this EV drive mode, the second rotary machine M12 produces electric torque. At this time, in the first rotary machine M11, the reverse rotation of the first rotary shaft 102 is restricted by the one-way clutch 106 and the first armature 114 is energized. This can make it possible to electrically drive the magnetic modulation element 116 which is connected to the second field element 119 via the rotor that is not connected to the first rotary shaft 102, i.e., the second rotor disc 120. In this way, necessary integrated torque can be produced in cooperation with the two rotors (the first and second rotary machines M11 and M12). This makes it possible to downsize the first and second rotary machines M11 and M12, thereby being able to provide a compact electric transmission 101.

In the electric transmission 101 according to the sixth exemplary embodiment, the front and rear frames 104 and 105 are combined by an axial spigot-joint of their opening portions. Inside these frames 104 and 105, the first and second rotary machines M11 and M12 are integrally contained. This structure makes it possible to reduce the number of components and to shorten the three-phase harnesses 123 and 131, compared to a structure in which the first and second rotary machines M11 and M12 are separately contained in separate frames. This can further promote downsizing of the entire electric transmission.

In the rear frame 105, a mounting space capable of mounting the two inverters 124 and 132 is ensured. Therefore, these inverters 124 and 132 need not to be located outside the electric transmission 101, and then, can be integrally mounted in the mounting space ensured in the rear frame 105. In the case where these inverters 124 and 132 are located outside the electric transmission 101, many harnesses are needed to connect the first and second rotary machine M11, M12 and these inverters 124 and 132 located outside. In the present embodiment, such many harnesses can be shortened and reduced. In this case, only DC (direct current) lines is needed as power harnesses. As a result, effects of wiring reduction are expected, and there is no need to design the surrounding area of connectors in order to extract harnesses from the first and second rotary machine M11 and M12, thereby being able to contribute downsizing and simplification of the electric transmission 101.

### Seventh Exemplary Embodiment

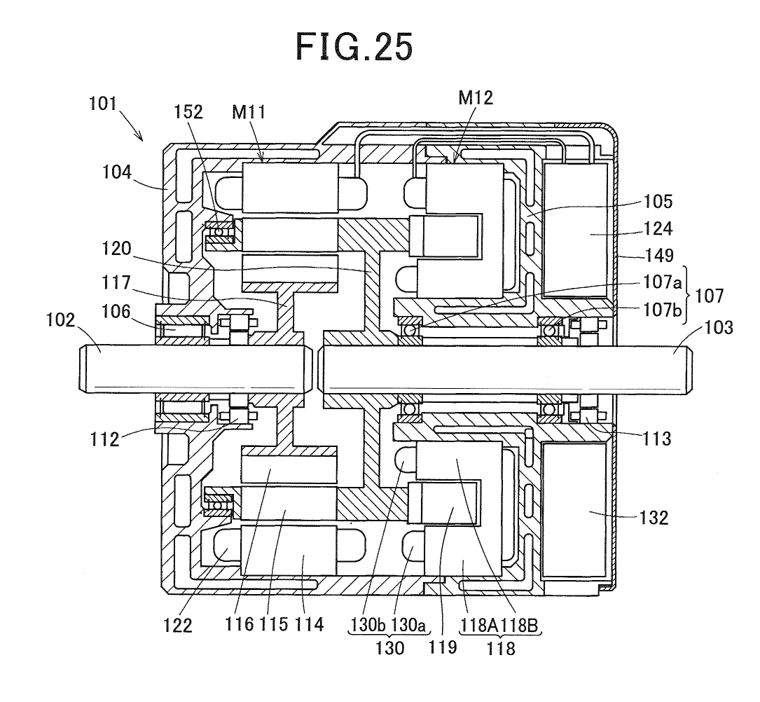

Referring to FIG. 25, the seventh exemplary embodiment is described. In the present embodiment, the components identical with or similar to those in the sixth exemplary embodiment are given the same reference numerals for the sake of omitting unnecessary explanation.

As shown in FIG. 25, in the electric transmission 101 of the present embodiment, the magnetic modulation element 116 of the first rotary machine M11 is coupled to the first rotary shaft 102 via the first rotor disc 117. The first field element 115 and the second field element 119 of the second rotary machine M12 are mechanically coupled to each other via the second rotor disc 120.

The first field element 115 is supported at the axial front side (left side of FIG. 25) through a bearing 152 in a rotatable manner with respect to the front frame 104.

According to a relationship of the number of poles based on the principle of magnetic modulation, the number of pole pairs of the first field element 115 is smaller than the number of segment poles 127 of the magnetic modulation element 116. In the case of the sixth exemplary embodiment, the number of pole pairs of the first field element 115 is n=10, and the number of segment poles 127 of the magnetic modulation element 116 is 16.

In the case of the present embodiment, a rotating speed of the first field element 115 is higher than the engine speed, compared to the case of sixth exemplary embodiment in which the first field element 115 is coupled to the first rotary shaft 102. Therefore, the first and second field elements 115 and 119 coupled to each other via the second rotor disc 120 rotate at a speed higher than the engine speed. This enables the second rotary machine M12 to be tailored to high speed and to be downsized. In addition, due to a relationship that a rotating speed of the propeller shaft 108 is higher than a rotating speed of the engine E11, the engine speed can be reduced during high speed driving using engine power, thereby resulting in fuel saving.

### (Modifications)

In the sixth and seventh exemplary embodiments, the second rotary machine M12 is configured by: (i) the outer armature 118A in which the second armature 118 is located at the outer periphery of the second field element 119; and (ii) the inner armature 118B located at the inner periphery of the second field element 119. This structure is a so called motor structure with a double face gap (two face gap) that forms a gap at the respective inner and outer peripheries of the second field element 119. In the exemplary embodiments described above, this motor structure with two-face gap is applied. In modifications of the embodiments described above, so called a motor structure with a triple face gap (three face gap) may be applied to the present disclosure. In this motor structure, another gap is further formed with the second armature 118, at the axial rear side of the second field element 119.

In another modifications, an ordinary used motor structure with a single face gap (one face gap) may be also applied to the present disclosure. In this motor structure, a redundant space can be formed inside of the second rotary machine M12. In this case, bearings and resolvers can be located in the redundant space. Due to such an effective use of space, a mounting space for the inverter can be largely ensured.

In the second armature 118 of the sixth exemplary embodiment, the outer and inner armatures 118A and 118B are integrally configured. Specifically, the armature core 129a of the outer armature 118A and the armature core 129b of the inner armature 118B are linked in the form of an approximately U-shaped cross section and integrally configured. Alternately, the armature cores 129a and 129b may be separately provided. In this case, the following features are the same as the sixth exemplary embodiment. The outer armature winding 130a wound around the outer armature 118A the inner armature winding 130b wound around the inner armature 118B are connected in series to each other every phase winding of the three-phase windings. The outer and inner armature windings 130a and 130b produce a winding magnetomotive force in such a manner that their poles, which are radially facing each other, have the same polarity in the same circumferential position.

In the sixth exemplary embodiment, the magnetic modulation element 116 is configured by a die-cast product which is integrally produced by casting the 16 segment poles 127 in high-strength aluminum material. However, there is no need to produce the magnetic modulation element 116 by die-casting. For example, the magnetic modulation element 116 may be formed by annularly connecting the 16 segment poles 127 by use of a connecting member, for example, non-magnetic mechanical structural member such as stainless steel.

In the configuration of the seventh exemplary embodiment, the magnetic modulation element 116 may be configured by: (i) forming the first rotary shaft 102 by use of high-strength non-magnetic stainless steel; and (ii) directly fixing the 16 segment poles 127 to the first rotary shaft 102 by welding or the like.

### Eighth Exemplary Embodiment

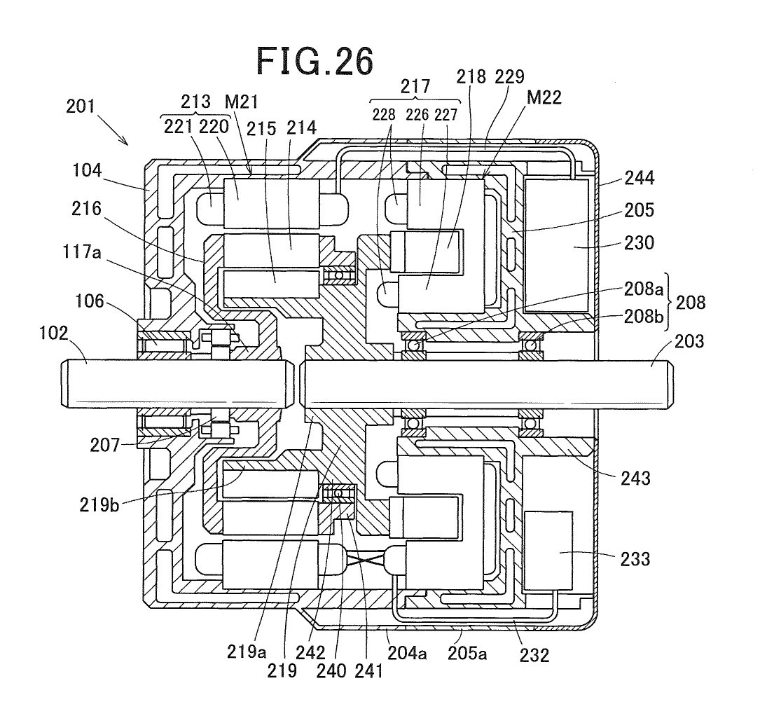

Referring to FIGS. 26 to 31, 32A, 32B, 33A, 33B, 34A, 34B, 35A and 35B, the eighth exemplary embodiment is described. In the present embodiment, an electric transmission using the magnetic modulation motor described above is applied to a hybrid vehicle.

As shown in FIG. 26, an electric transmission 201 according to the present embodiment includes: a first rotary machine M21 having a first rotary shaft 202; a second rotary machine M22 having a second rotary shaft 203; a front frame 204 mainly covering an outer periphery of the first rotary machine M21; and a rear frame 205 mainly covering an outer periphery of the second rotary machine M22.

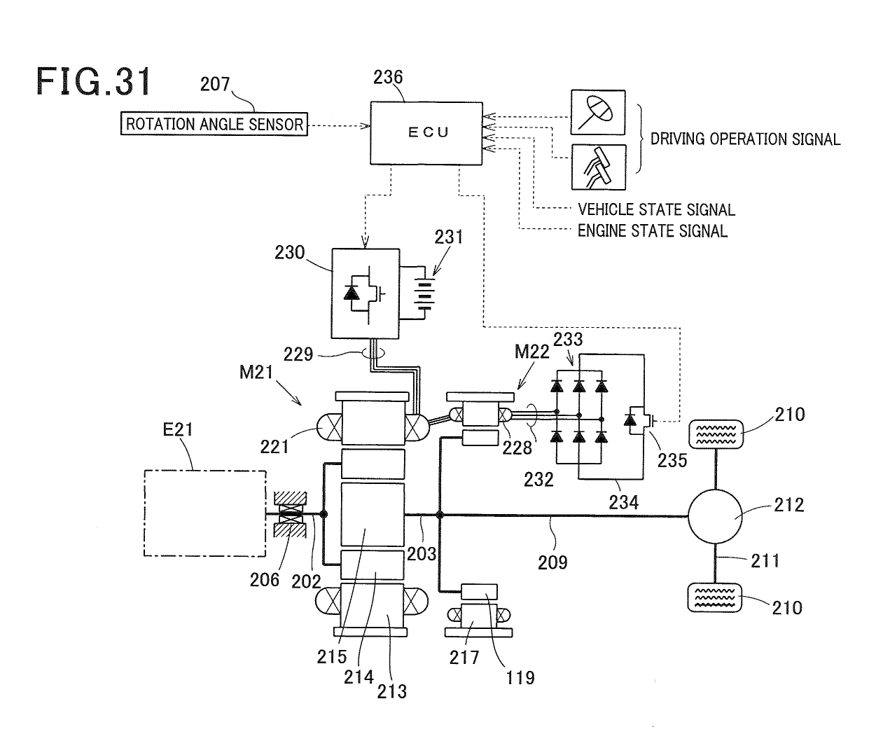

The first rotary shaft 202 is rotatably supported by the front frame 204 via an one-way clutch 206 also functioning as a first bearing. This first rotary shaft 202 has an axial end portion which projects from the front frame 204 toward an axial outside (left side in FIG. 26). As shown in FIG. 31, this axial end portion is directly or indirectly connected to a crank shaft (not shown) of an engine E21.

The one-way clutch 206 is configured by, for example, a well-known roller type clutch and has a function for allowing the first rotary shaft 202 to rotate in only a positive rotational direction of the engine E21 and for preventing it from rotating in the reverse rotational direction thereof.

In the first rotary shaft 202, a rotation angle sensor 207 is mounted. This rotation angle sensor 207 is configured by, for example, a resolver, and detects a rotation angle position of the first rotary shaft 202.

The second rotary shaft 203 is arranged in such a manner that its shaft center is coincident with a shaft center of the first rotary shaft 202, and is rotatably supported by the rear frame 205 via two bearings (second bearing) 208. This second rotary shaft 203 has an a axial end portion which projects from the rear frame 205 toward an axial outside (right side in FIG. 26). As shown in FIG. 31, this axial end portion is directly or indirectly connected to a propeller shaft 209. This propeller shaft 209 is connected to a final stage reducer 212 with a differential mechanism for transferring a turning force (torque) to an axle 211 of a driving wheel 210.

As shown in FIG. 26, the first rotary machine M21 includes: (i) an armature (hereinafter referred to as “first armature 213”) which is fixed to the front frame 204; (ii) a field element 214 which is rotatably arranged at an inner periphery side of this first armature 213 via a gap; and (iii) a magnetic modulation element 215 which is rotatably arranged at an inner periphery side of this first field element 214 via a gap. The first field element 214 is connected to the first rotary shaft 202 via a first rotor disc 216.

The first rotor disc 216 is made of a non-magnetic metal material (for example, aluminum material) and includes a cylindrical boss section 216a at its radial central portion. The cylindrical boss section 216a is fixed to an outer periphery of the first rotary shaft 202 by, for example, a serration fitting or a key coupling, and then, integrally rotates together with the first rotary shaft 202.

As shown in FIG. 26, the second rotary machine M22 is configured by an induction motor that includes: (i) an armature (hereinafter referred to as “second armature 217”) which is fixed to the rear frame 205; and (ii) a squirrel-cage rotor (hereinafter referred to as “second rotor 119”) which is rotatably arranged relative to this second armature 118 via a gap. The second rotor 119 is connected to the second rotary shaft 203 via a second rotor disc 219.

As is the case with the first rotor disc 216, the second rotor disc 216 is made of a non-magnetic metal material (for example, aluminum material) and includes a cylindrical boss section 219a at its radial central portion. The cylindrical boss section 219a is fixed to an outer periphery of the second rotary shaft 203 by, for example, a serration fitting or a key coupling, and then, integrally rotates together with the second rotary shaft 203.

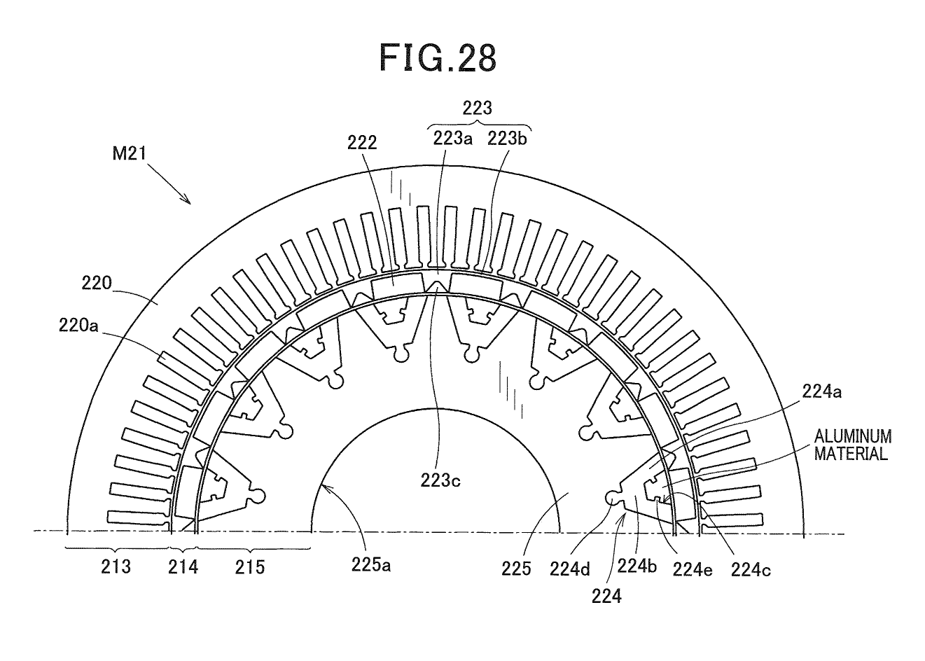

Next, referring to FIGS. 26 to 28, a configuration of the first rotary machine M21 is described in detail. FIG. 28 is a partial transverse cross-sectional view of the first rotary machine M21, which is perpendicular to a shaft center direction of the first rotary machine M21. In FIG. 28, hatching showing the cross-section is omitted.

The configuration of the first rotary machine M21 is based on the magnetic modulation motor as described in the first to fifth exemplary embodiments, for example, the second exemplary embodiment as shown in FIG. 11.

### (Description of First Armature)

The first armature 213 includes an annular armature core 220 and an armature winding 220 with m=6 pole pairs (see FIG. 28). In the armature core 220, a plurality of slots 220a (72 slots in the eighth exemplary embodiment) are circumferentially formed at regular pitches. The armature winding 220 is wound around the armature core 220 through the slots 220a.

The armature core 220 is configured by laminating a plurality of annular core sheets in which the slots 220a are formed by punching an electromagnetic steel plate.

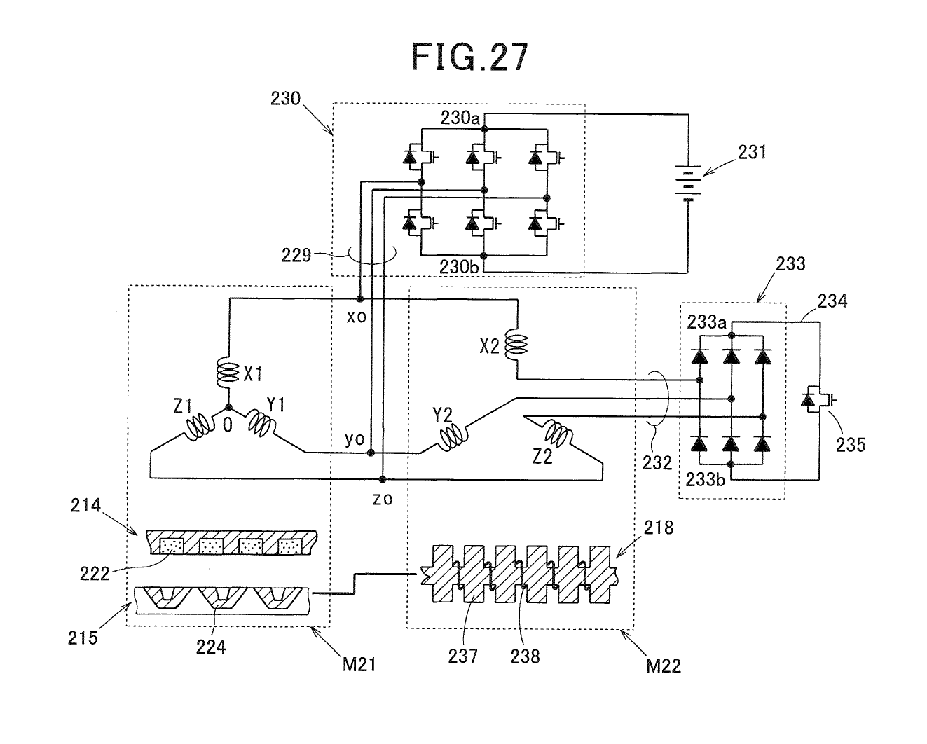

As shown in FIG. 27, the armature winding 221 is configured by a star connection of three-phase windings (hereinafter referred to as “first three-phase windings X1, Y1, Z1”) in which a phase of each is set at 120° apart from each other.

### (Description of Field Element 214)

As shown in FIG. 27, the field element 214 includes: 20 permanent magnets 222 (for example, neodymium magnets) forming poles with n=10 pole pairs; and a soft magnetic material 223 holding the 20 permanent magnets 222.

The 20 permanent magnets 222 are circumferentially arranged at regular intervals and are radially magnetized. The circumferential adjacent two poles (permanent magnets 125) are magnetized in such a way as to differ from each other in polarity.

The soft magnetic material 223 includes a plurality of interpolar soft magnetic materials 223a and a ring-like soft magnetic material 223b. Each of the interpolar soft magnetic materials 223a is located between each circumferentially adjacent two permanent magnets 222. The ring-like soft magnetic material 223b covers a first armature side surface of the permanent magnets 213, and is arranged completely around the circumferential surface of the field element 214 facing the first armature 213.

The interpolar soft magnetic materials 223a and the ring-like soft magnetic material 223b are configured by laminating a plurality of soft magnetic material sheets which are formed into both shapes by punching press of an electromagnetic steel plate. The interpolar soft magnetic materials 223a and the ring-like soft magnetic material 223b are integrally provided in the present embodiment, but may be separately provided.

In each of the interpolar soft magnetic materials 223a, a concave portion (recess) 223c is formed at an inner diameter side facing the magnetic modulation element 215. The concave portion 223c has a depth of approximately ⅔ of a width between an inner diameter face and an outer diameter face (i.e., a radial size) of the field element 214 and is formed into a taper shape in which an circumferential opening width is gradually widened from the deepest portion toward the inner diameter face of the field element 214.

### (Description of Magnetic Modulation Element 215)

The magnetic modulation element 215 includes: 16 (m+n) segment poles (segments) 224 forming a path of magnetic flux; and a rotor hub (metal member) 225 holding the 16 segment poles 224. As shown in FIG. 26, this magnetic modulation element 215 is supported by the second rotor disc 219 in such a manner that an outer periphery of a cylindrical support 219b integrated with the second rotor disc 219 is fitted in a circular hole 225a (see FIG. 28) which is located at an inner periphery of the rotor hub 225. Thus, the magnetic modulation element 215 is connected to the second rotary shaft 203 via the second rotor disc 219, and then, integrally rotates together with the second rotary shaft 203.

The segment poles 224 are configured by laminating a plurality of segment parts formed into an approximate V-shape (see a shape shown in FIG. 28) by punching an electromagnetic steel plate.

Hereinafter, two sides of the segment magnetic pole 224 which are opened into a V-shape are referred to as “two segment arm sections 224a”. A base (root) side of the two segment arm sections 127a is referred to as “segment base section 224b”. A recess (concave portion) formed between the two segment arm sections 224a is referred to as “segment concave portion 224c”.

The 16 segment poles 224 are annularly arranged in a circumferential direction of the magnetic modulation element 215 at regular intervals. In such an arrangement of the segment poles 224, the two segment arm sections 224a are open into a V-shape radially outward, i.e., the segment base section 224b faces radially inside. In the present embodiment, a dovetail-shaped anchor section 224d is formed in the bottom face of the segment base section 224b. In the side surface of the respective segment arm sections 224a, a pair of locking parts 224e are provided in such a way as to project toward the segment concave portion 224c.

The rotor hub 225 is made of high-strength aluminum material (for example, duralumin) which is a non-magnetic and good electric conductor, and is produced by die-casting in which the 16 segment poles 224 are integrally cast. Thus, the anchor section 224d, provided in the segment base section 224b, is buried in aluminum material, and then, each of the segment poles 224 is tightly fixed to the rotor hub 225. In addition, the segment concave portion 224c is filled with the same aluminum material which is locked by the pair of locking parts 224e projecting from the side surface of the respective segment arm sections 224a. This prevents aluminum material from being detached from the segment concave portion 224c.

The 16 segment poles 224, held by the rotor hub 225, are magnetically separated from one another by aluminum material filled between the circumferentially adjacent two segment poles 224. Each of the 16 segment poles 224 is not fully filled in aluminum material. Therefore, an apical face of the respective segment arm sections 224a exposes on the outer diameter face of the rotor hub 225, thereby forming an entry and exit of magnetic flux (magnetic flux entry and exit).

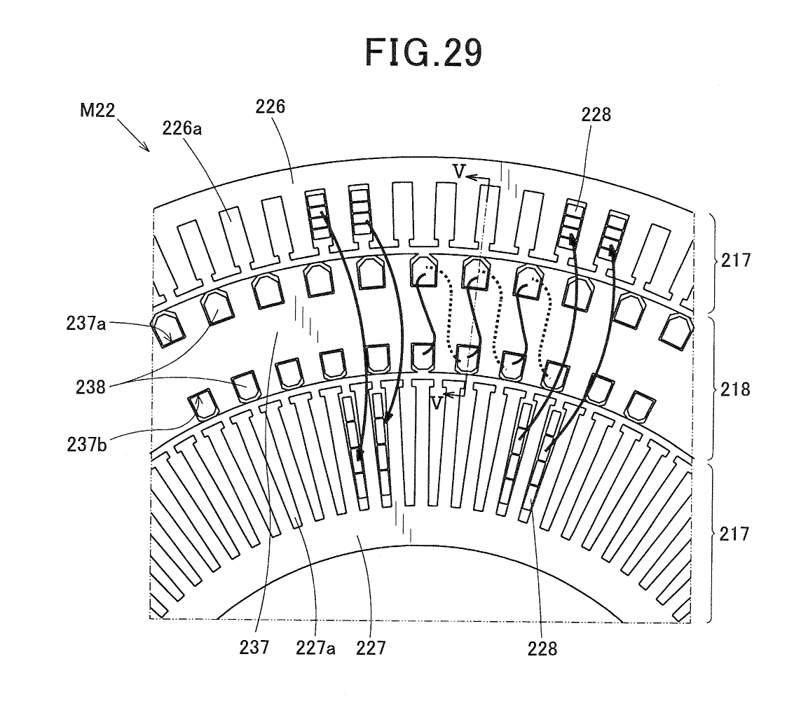

Next, referring to FIGS. 26, 27, 29 and 30, a configuration of the second rotary machine M22 is described in detail. FIG. 29 is partial transverse cross-sectional view of the second rotary machine M22, which is perpendicular to a shaft center direction of the second rotary machine M22. In the FIG. 29, hatching showing the cross-section is omitted.

### (Description of Second Armature 217)

As shown in FIG. 29, the second armature 217 includes an outer armature core 226, an inner armature core 227, and an armature winding 228 (see FIG. 26) The outer armature core 226 is located at the side of the outer periphery of the second rotor 218. The inner armature core 227 is located at the side of the inner periphery of the second rotor 218. The armature winding 228 is wound the outer and inner armature cores 226 and 227 through a plurality of outer and inner slots 226a and 227a (e.g., 96 outer and inner slots in the present embodiment) which are circumferentially formed in the outer and inner armature cores 226 and 227 at regular pitches. The number of the outer slots 226a is the same as that of the inner slots 227a (in the present embodiment, 96 outer slots 226a are formed in the outer and inner armature cores 226, and 96 inner slots 227a are formed in the inner armature cores 227).

The outer and inner armature cores 226 and 227 are configured by laminating a plurality of annular core sheets in which the outer and inner slots 226a and 227a are formed by a punching press of an electromagnetic steel plate. The outer and inner armature core 226a and 227a are mechanically connected to each other at the axial rear side (right side of FIG. 26).

As shown in FIG. 27, the armature winding 228 includes three-phase windings (hereinafter referred to as “second three-phase windings X2, Y2, Z2”) in which a phase of each is set at 120° apart from each other. The second three-phase windings X2, Y2, Z2 are wound around the outer and inner armature cores 226 and 227 in the form of a distributed winding with a predetermined winding pitch satisfying the following conditions: (i) the number of slots per pole per phase is q=2; and (ii) the number of poles is 16 (i.e., the number of pole pairs is 8).

The second three-phase windings X2, Y2, Z2 are connected to the first three-phase windings X1, Y1, Z1 configuring the armature winding 221 of the first armature 213 in such a manner that their phase sequence is a negative sequence.

Here, (i) three-phase connection points, at which the first and second three-phase windings X1, Y1, Z1 and X2, Y2, Z2 are connected to each other, are referred to as “three-phase connection points x0, y0, z0”, (ii) three-phase terminals opposite to the three-phase connection points x0, y0, z0 of the first three-phase windings X1, Y1, Z1 are referred to as “first three-phase terminals”, and (iii) three-phase terminals opposite to the three-phase connection points x0, y0, z0 of the second three-phase windings X2, Y2, Z2 are referred to as “second three-phase terminals”. The three-phase connection points x0, y0, z0 are connected to an inverter 230 via a three-phase harness 229. This inverter 230 has DC (direct current) terminals 230a, 230b that are connected to a vehicle battery 231 which is a DC power supply.

The first three-phase windings X1, Y1, Z1 are connected in the form of a star connection in which the first three-phase terminals form its neutral point O. In the second three-phase windings X2, Y2, Z2, the second three-phase terminals are connected to a well-known three-phase full-wave rectifier (hereinafter referred to as a “rectifier 233”) via a three-phase harness 232.

The rectifier 233 has positive and negative terminals 233a, 233b that are connected to a short circuit 234 which is provided with a semiconductor switch 235 (for example, a transistor).

As shown in FIG. 31, operation of the inverter 230 and on/off (close/open) operation of the semiconductor switch 235 are controlled by a powertrain integrated ECU (electronic control unit) 236 which is mounted in the vehicle.

The ECU 236 receives information, for example, (a) a vehicle state signal including a steering angle signal, an acceleration position signal, a brake signal, a shift position signal, (b) an engine state signal for informing engine state such as start and stop of the engine E21, and (c) a detected signal of the respective rotation angle sensors 207. And then, based on these information, the ECU 151 controls operation of the inverter 230 and on/off (close/open) operation of the semiconductor switch 235.

### (Description of Second Rotor 218)

The second rotor 218 is configured by an annular rotor core 237 and a squirrel-cage conductor which is assembled in this rotor core 237.

As shown in FIG. 29, the rotor core 237 is configured by laminating a plurality of annular core sheets formed by a punching press of an electromagnetic steel plate. In the rotor core 237, the outer and inner slots 237a and 237b are circumferentially formed at the radial outer and inner peripheries the rotor core 237 at regular pitches. The number of the outer and inner slots 237a is the same as that of the inner slots 237b.

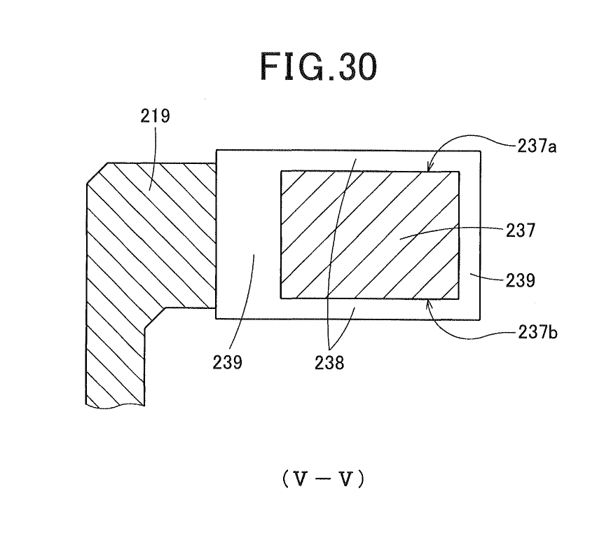

As shown in FIG. 30, the squirrel-cage conductor is configured by a plurality of rotor bars 238 and an end ring 239. The rotor bars 238 are inserted in the outer and inner slots 237a and 237b formed in the rotor core 237. The end ring 239 short-circuits both ends of the respective rotor bars 238. The rotor bars 238 and the end ring 239 are produced by, for example, aluminum die-casting, in such a way as to be configured by aluminum material which is conductive material.

Next, referring to FIG. 26, features related to an overrall configuration of the electric transmission 201 are described below. In the following explanation, a left side of an axial direction (left-right direction shown in FIG. 26) is referred to as a “front side”, and a right side of the axial direction is referred to as a “rear side”.

In the first and second rotary machines M21 and M22, the magnetic modulation element 215 of the first rotary machine M21 and the second rotor 218 of the second rotary machine M22 are mechanically coupled to each other via the second rotor disc 210. The magnetic modulation element 215 and the second rotor 218 are configured so as to integrally rotate with the second rotary shaft 203.

The first and second rotary shafts 202 and 203 are located in such a manner that an opposite central position between both rotary shafts 202 and 203 axially facing each other via a gap is displaced to the front side. In other words, the opposite central position between the first and second rotary shafts 202 and 203 is shifted toward the front side from an axially intermediate position (hereinafter referred to as an “axially central position”) between the first and second rotary machines M21 and M22. In the case of FIG. 26, a front side end surface of the second rotary shaft 102 extends beyond the axially central position, and then reaches up to the inner periphery side of the first rotary machine M21.

Thus, the second rotor disc 219 can allow the cylindrical boss section 219a, which is fitted in the second rotary shaft 203, to be located at a position (axially central) between the first and second rotary machines M21 and M22.

In addition, (i) the field element 214 of the first rotary machine M21 and (ii) two rotors (the magnetic modulation element 215 and the second rotor 218) connected to each other via the second rotor disc 219, are supported in a relatively rotatable manner via a bearing 240 which is located at approximately axially intermediate position (axially central position) between both two rotors. Specifically, the field element 214 is provided with an outer support section 241 on a rear side end surface of the field element 214. The second rotor disc 219 is provided with an inner support section 219 which radially facing the outer support section 241. The field element 214 and two rotors (the magnetic modulation element 215 and the second rotor 218) are supported in a relatively rotatable manner via the bearing 240 located between the outer and inner support sections 241 and 242.

In the present embodiment, the inner support section 242 may be located on the rear side end surface of the field element 214, and the outer support section 242 may be located in the second rotor disc 219.

The two bearings 208, which support the second rotary shaft 203 with respect to the rear frame 205, are spaced at a predetermined distance. Hereinafter, one of the two bearings 208 which is located at the front side (left side of FIG. 26) is referred to as a “first rear bearing 208a”, and the other which is located at the rear side (right side of FIG. 26) is referred to as a “second rear bearing 208b”. The first rear bearing 208a is located close to the axially central position. Specifically, the first rear bearing 208a is located close to the rear side of the cylindrical boss section 219a of the second rotor disc 219.

The front and rear frames 204 and 205 are combined by an axial spigot-joint of their opening portions. Inside the front and rear frames 204 and 205, the first and second rotary machines M21 and M22 are integrally contained.

The rear frame 205 is integrally provided with an cylindrical frame 243 at the radial inner periphery side of the rear side end surface. In the cylindrical frame 243, a cylindrical bearing section is axially extended. The cylindrical bearing section supports the outer periphery of the second rear bearing 208b. Radially outside the cylindrical frame 243, a mounting space capable of mounting the inverter 230 and the rectifier 233 described above is ensured.

Outside the rear frame 205 (right end of FIG. 26), a rear cover 244 is assembled. The rear cover 244 covers a the inverter 230 and the rectifier 233 mounted in the mounting space described above.

The front and rear frames 204 and 205 are integrally provided with harness protectors 204a and 205a that protect (i) a three-phase harness 229 connected to the inverter 230 and (ii) a three-phase harness 232 connected to the rectifier 233.

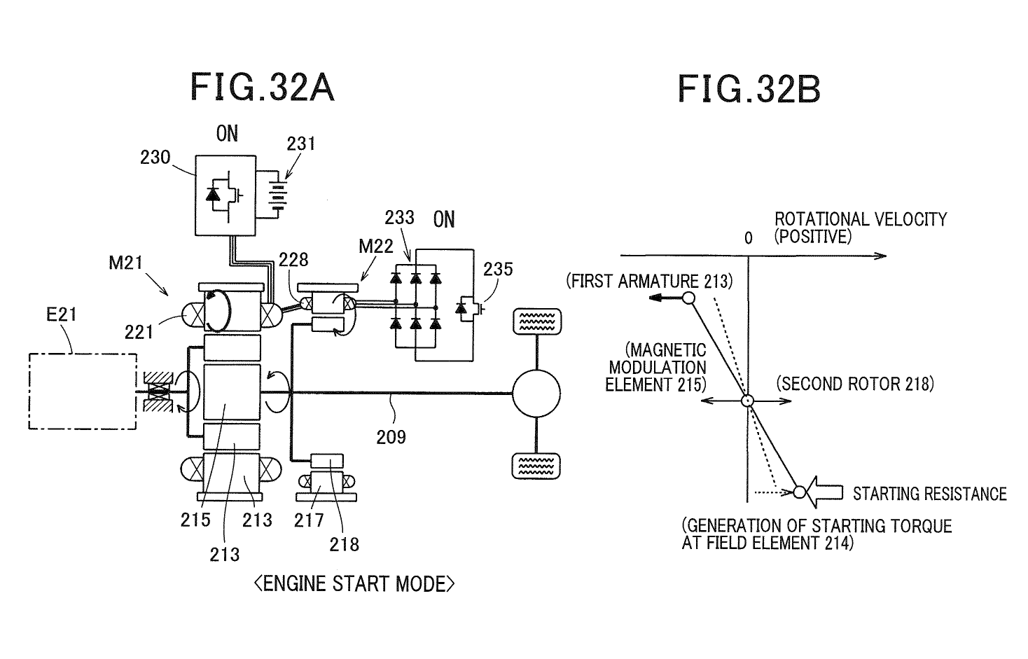

Next, referring to FIGS. 32A, 32B, 33A, 33B, 34A, 34B, 35A and 35B, operation of the electric transmission 201 is described. FIGS. 32A, 33A, 34A and 35A show diagrams for explaining operations corresponding to several drive modes required for hybrid vehicles, and FIGS. 32B, 33B, 34B and 35B show motion diagrams of the first rotary machine M21. Each of the motion diagrams represents a relationship between (i) the field element 214 and the magnetic modulation element 215 which are two rotors of the first rotary machine M21; and (ii) mechanical angular velocity of rotating magnetic field produced by the armature winding 221 of the first armature 213.

Hereinafter, a positive rotational direction of the engine E21 is referred to as a “positive direction”, and an opposite direction of the positive rotational direction of the engine E21 is referred to as a “reverse direction”.

### a) Engine Start Mode

In an engine start mode, the engine E21 is started. This operation is described with reference to FIGS. 32A and 32B.

First, the field element 214, which is connected to the first rotary shaft 202, is static, i.e., the engine E21 is stopped. Under this condition, operation of the inverter 230 is controlled by the ECU 236 in such a manner that a rotating magnetic field directed to an opposite direction of a rotational direction of the engine E21 is generated in the armature winding 221 (the first three-phase windings X1, Y1, Z1) of the first armature 213, as shown in left-pointing arrows of FIG. 32B. Then, the magnetic modulation element 215 tries to rotate in the opposite direction (the same direction as the rotating magnetic field produced by the first armature 213), as shown in arrows of FIG. 32A.

On the other hand, in the armature windings 221 and 228 of the first and second armatures 213 and 217, the first three-phase windings X1, Y1, Z1 and the second three-phase windings X2, Y2, Z2 are connected to each other in such a manner that their phase sequence is a negative sequence. Then, when the semiconductor switch 235, which is inserted between the positive and negative terminals 233a, 233b of the rectifier 233, is turned on, as shown in FIG. 32A, a rotating magnetic field produced by the armature winding 228 (the second three-phase windings X2, Y2, Z2) rotates in the positive direction (corresponding to a direction indicated by arrows of FIG. 32A).

In this way, as shown in right-pointing allows of FIG. 32B, the second rotor 218 tries to rotate in such a way as to follow the rotating magnetic field produced by the armature winding 228 with a slip. This leads to an action to restrict a reverse rotation of the magnetic modulation element 215 connected to this the second rotor 215. As its reaction, a torque of a positive direction is generated in the field element 214. Thus, as shown in FIG. 32A, the crank shaft of the engine E21 connected to the first rotary shaft 202 rotates in the positive direction (corresponding to a direction indicated by arrows of FIG. 32A), thereby starting the engine E11. In this engine start mode, the second rotary machine M22 also assists a start of the engine E21.

### b) Engine Acceleration and Axle Activation Mode

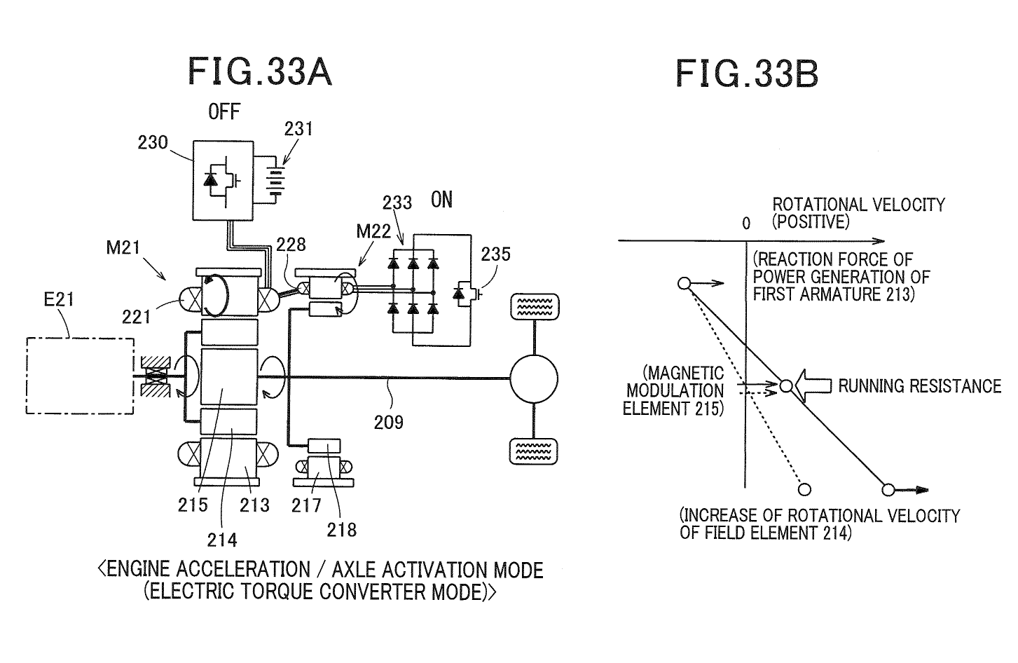

In an engine acceleration and axle activation mode, the engine E21 is accelerated to activate an axle side, thereby starting and accelerating the vehicle. This operation is described with reference to FIGS. 33A and 33B.

In this operation, as an engine speed is increased, a rotational velocity of the field element 214 is increased. Subsequently, the magnetic modulation element 215, which is connected to the second rotary shaft 203 located at the axle side, receives reaction force due to vehicle inertial resistance or the like, as shown in left-pointing arrows of FIG. 33B. Thus, the rotating magnetic field of the first armature 213 is directed to a reverse rotation. In this state, the first armature 213 generates electric power to provide its reaction force. Then, the magnetic modulation element 215 receives rotational torque due to the reaction force of power generation and the drive force of the engine E21, and increases the rotational velocity, as shown in right-pointing arrows of FIG. 33B.

The power generation of the first armature 213 is performed as follows.

As shown in FIG. 33A, under the condition that the inverter 230 is turned off, the semiconductor switch 235, which is inserted between the positive and negative terminals 233a, 233b of the rectifier 233, is turned on. Then, when voltage is induced in the first three-phase windings X1, Y1, Z1, current flows in the second three-phase windings X2, Y2, Z2, which is connected to the first three-phase windings X1, Y1, Z1 in such a manner that their phase sequence is a negative sequence, thereby exciting the second three-phase windings X2, Y2, Z2 in the positive direction (corresponding to a direction indicated by arrows of FIG. 33A).

When the engine speed reaches a predetermined engine speed, the second rotor 218 overcomes the running resistance to provide rotational drive force, and starts to rotate with a slip with respect to a velocity of the rotating magnetic field generated by the second three-phase windings X2, Y2, Z2. At this time, as shown in FIG. 33A, the magnetic modulation element 215 receives rotational torque in the positive direction (corresponding to a direction indicated by arrows of FIG. 33A) due to the reaction force of power generation of the reverse direction which is received by the field element 214 from the first armature 213. Then, the magnetic modulation element 215 assists a rotation of the second rotary shaft 203 as well as the second rotor 218.

### c) EV Drive Mode

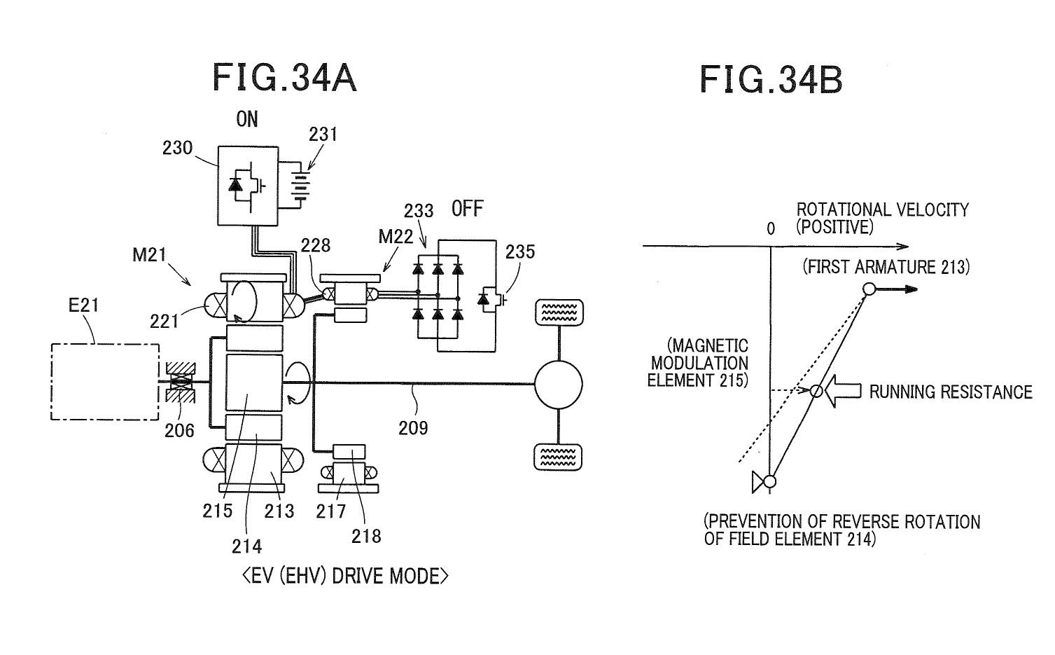

In an EV drive mode, the engine E21 is stopped, and the vehicle is driven by only a motor. This operation is described with reference to FIGS. 34A and 34B.

The first rotary machine M21 is accelerated by supplying the first armature 213 with the electric power while receiving a rotational resistance of the magnetic modulation element 215 which is connected to the second rotary shaft 203. Then, a torque, which tries to rotate in the reverse direction, acts on the field element 214 connected to the first rotary machine 202. At this time, as shown in right-pointing triangular marks of FIG. 34B, the one-way clutch 206 prevents the field element 214 from reversely rotating, and then, its magnetic torque reaction force acts on the magnetic modulation element 215. Therefore, a drive torque, which rotates the second rotary shaft 203 connected to the axle side in the positive direction (corresponding to a direction indicated by arrows of FIG. 34B), is generated. In this way, due to the presence of the one-way clutch 206 that prevents the reverse rotation of the first rotary shaft 202, the first rotary machine M21 can also electrically operate as well as the second rotary machine M22. This can downsize the first rotary machine M21 as well as the second rotary machine M22.

In the EV drive mode, the semiconductor switch 235 is turned off, such that the second three-phase windings X2, Y2, Z2 does not operate, and the vehicle is driven by only the first rotary machine M21.

### d) Vehicle Regenerative Control Mode

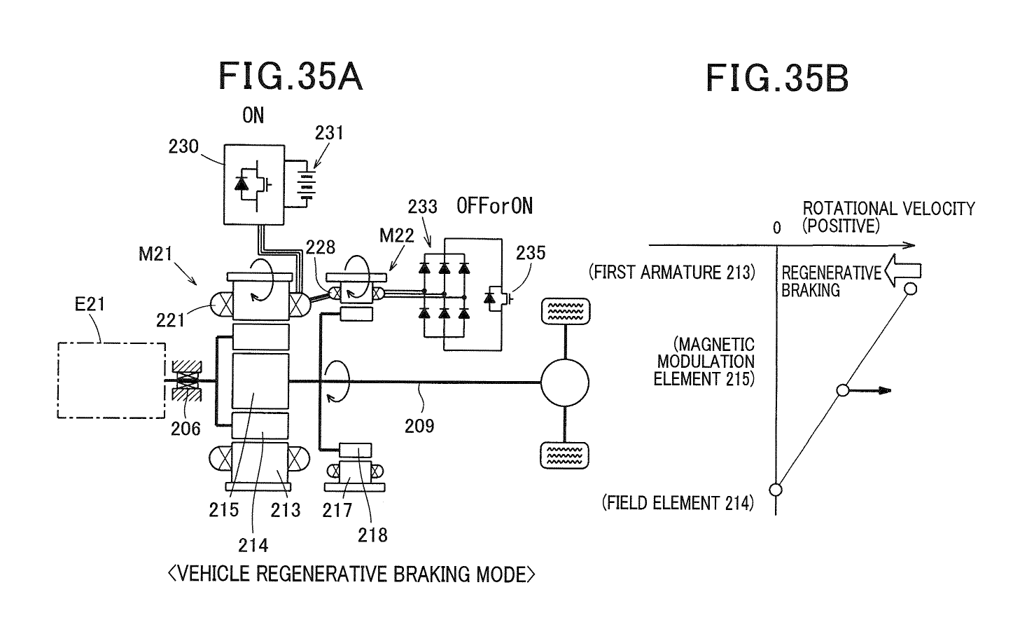

In a vehicle regenerative control mode, the running vehicle is decelerated and a regenerative braking is produced. This operation is described with reference to FIGS. 35A and 35B.

In this mode, it is necessary to stop a rotation of the field element 214 of the first rotary machine M21 in order to efficiently charge the vehicle battery 231 with braking energy as much as possible. For such a measure, there are two methods.

As shown in FIG. 35A, the first method is a method for: generating electric power at the second three-phase windings X2, Y2, Z2 by use of the regenerative braking, while controlling an output frequency of the inverter 230 with respect to the first armature 213 in such a manner that a rotation of the field element 214 is zero. At this time, if the semiconductor switch 235 is turned on, a rotating magnetic field of the reverse direction is generated in the second three-phase windings X2, Y2, Z2. Therefore, the semiconductor switch 235 is turned off, so as to make the second rotary machine M22 ineffective.

The second method is a method for: (i) controlling the inverter 230 in such a manner that: (a) a rotating magnetic field produced by the first three-phase windings X1, Y1, Z1 is in the reverse direction with respect to the first rotary machine M21; and (b) a rotating magnetic field produced by the second three-phase windings X2, Y2, Z2 is in the reverse direction with respect to the second rotary machine M22; and (ii) generating electric power at the second rotary machine M22 by use of the regenerative braking. In this case, the rotating magnetic field in the reverse direction is generated in the first armature 213. Due to this, a phase control is performed by selecting a phase angle in such a way that a torque does not act on the field element 214 and the magnetic modulation element 215. This enables the field element 214 to rotate freely, thereby preventing braking energy from being lost due to engine braking or the like. Thus, during the regenerative braking, the first rotary machine M21 can function as a power cutoff clutch. As a result, the vehicle battery 231 can be efficiently charged with braking energy.

### (Effects of Eighth Exemplary Embodiment)

According to the eighth exemplary embodiment, (i) the first three-phase windings X1, Y1, Z1 are wound around the armature core 220 of the first rotary machine M21, the second three-phase windings X2, Y2, Z2 are wound around the outer and inner armature cores 226, 227 of the second rotary machine M22, and (iii) the first three-phase windings X1, Y1, Z1 and the second three-phase windings X2, Y2, Z2 are connected to each other in such a manner that their phase sequence is a negative sequence. Then, for example, the engine E21 is rotated at high speed and the axle is rotated at low speed, i.e., the first rotary machine M21 generates electric power while the first three-phase windings X1, Y1, Z1 generate a rotating magnetic field of the reverse direction to the rotational direction of the engine E21. By current due to this generated power, a rotating magnetic field of the positive direction is generated in the second three-phase windings X2, Y2, Z2 of the second rotary machine M22. This rotating magnetic field induces magnetic field generated in the second rotor 218 of the second rotary machine M22 which is the squirrel-cage rotor. Thus, the second rotor 218 rotates in the positive direction with a slip.

As a result, the second rotary machine M22 can be electrically driven by using the generated power of the first rotary machine M21 without a dedicated inverter, which can correspond to several drive modes required for hybrid vehicles even if one inverter 230 described in the eighth exemplary embodiment is available.

According to the first rotary machine M21 of the eighth exemplary embodiment, the magnetic modulation element 215 is not located between the first armature 213 and the field element 214, and can be located at the opposite side (the most inner diameter side of the first rotary machine M21 in the present embodiment) of the first armature 213 with respect to the field element 214. Thus, magnetic flux passing though the magnetic modulation element 215 forms a flow that U-turns around the segment poles 224 formed into the approximate V-shape, without interlinkage with the rotor hub 225 holding the segment poles 224. This causes no generation of large loop eddy current, even if the 16 segment poles 224 are cast in high-strength aluminum material. In other words, the 16 segment poles 224 can be reliably and easily supported and fixed by the high-strength aluminum material. This makes it possible to improve mechanical rigidity of the magnetic modulation element 215, which can improve vibration resistance and centrifugal force resistance of the magnetic modulation element 215. This enables the magnetic modulation element 215 to be tailored to high rotation and high torque specification.

In the two rotors (the field element 214 and the magnetic modulation element 215) of the first rotary machine M21 and the second rotor 218 of the second rotary machine M22, two rotor (the magnetic modulation element 215 and the second rotor 218), which are connected to each other, and the field element 214 of the first rotary machine M21 are supported in a relatively rotatable manner via the bearing 240 which is inserted between: (i) the outer support section 241 located at the axial rear side of the field element 214; and (ii) the inner support section 242 provided in the second rotor disc 219. In the second rotor disc 219, the cylindrical boss section 219a is located at the radial central portion that extends toward the inner diameter side from the inner support section 242 supporting the bearing 240 with the outer support section 241. The second rotor disc 219 is fixed by fitting the cylindrical boss section 219a in the outer periphery of the second rotary shaft 203.

The second rotary shaft 203 is rotatably supported by the rear frame 205 via the two bearings 208 (the first rear bearing 208a and the second rear bearing 208b) axially spaced at a predetermined axial distance. Specifically, the first rear bearing 208a is located adjacent to the rear side of the cylindrical boss section 219a of the second rotor disc 210 in which the second rotary shaft 203 is fitted. This can improve rigidity of the magnetic modulation element 215 and the second rotor 218, thereby being able to provide a durable structure.

The field element 214 of the rotary machine M21 has (i) an axial front side which is connected to the first rotary shaft 202 via the first rotor disc 216, and (ii) an axial rear which is supported by the second rotor disc 219 via the bearing 240 described above. Therefore, both axial ends of the field element 214 are supported. Such a structure of the field element 214 is referred to as a “both ends supported structure”. This structure can improve also vibration resistance of the field element 214.

Thus, it is possible to improve accuracy of the shaft center of the electric transmission 201 in which the first and second rotary machines M21 and M22 are integrally provided, and to improve durability thereof, thereby being able to be used at high speed.

Further, a body of the first and second rotary machines M21 and M22 used for the electric transmission 201 of the eighth exemplary embodiment is determined by a condition that can supply an output necessary for the EV drive mode in which the engine E21 does not operate and the vehicle is driven by only the vehicle battery 231. In this EV drive mode, the second rotary machine M22 produces electric torque. At this time, in the first rotary machine M21, the reverse rotation of the first rotary shaft 202 is restricted by the one-way clutch 206 and the first armature 213 is energized. This can make it possible to electrically drive the magnetic modulation element 215 which is connected to the second rotor 218 via the rotor that is not connected to the first rotary shaft 202, i.e., the second rotor disc 219. In this way, necessary integrated torque can be produced in cooperation with the two rotors (the first and second rotary machines M11 and M12). This makes it possible to downsize the first and second rotary machines M21 and M22, thereby being able to provide a compact electric transmission 201.

In the electric transmission 201 according to the eighth exemplary embodiment, the front and rear frames 204 and 205 are combined by an axial spigot-joint of their opening portions. Inside these frames 204 and 205, the first and second rotary machines M21 and M22 are integrally contained. This structure makes it possible to reduce the number of components and to shorten the three-phase harnesses 229 and 232, compared to a structure in which the first and second rotary machines M21 and M22 are separately contained in separate frames. This can further promote downsizing of the entire electric transmission.

Outside the rear frame 205, a mounting space capable of mounting the inverter 230 and the rectifier 233 is ensured. Therefore, the inverter 230 and the rectifier 233 need not to be located outside the electric transmission 201, and then, can be integrally mounted in the mounting space ensured outside the rear frame 205. In the case where the inverter 230 and the rectifier 233 are located outside the electric transmission 201, the three phase harnesses 229 and 232 are needed to connect the first and second rotary machine M21, M22 and the inverter 230 and the rectifier 230 located outside. In the present embodiment, the three-phase harnesses 229 and 232 can be shortened and reduced. In this case, only DC (direct current) lines is needed as power harnesses. As a result, effects of wiring reduction are expected, and there is no need to design the surrounding area of connectors in order to extract the three-phase harnesses 229 and 232 from the first and second rotary machine M21 and M22, thereby being able to contribute downsizing and simplification of the electric transmission 201.

### Ninth Exemplary Embodiment

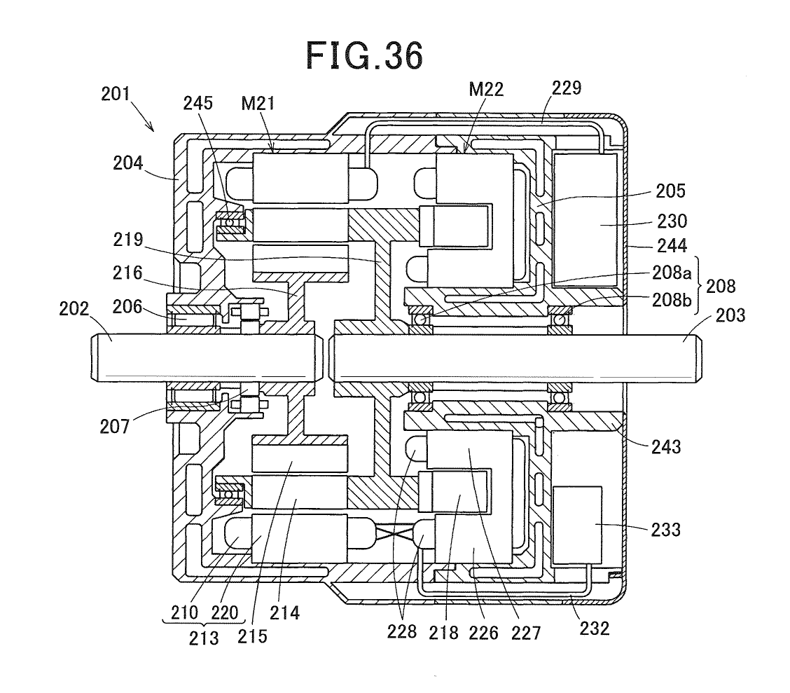

Referring to FIG. 36, the ninth exemplary embodiment is described. In the present embodiment, the components identical with or similar to those in the eighth exemplary embodiment are given the same reference numerals for the sake of omitting unnecessary explanation. The following explanation focuses on differences with the eighth exemplary embodiment.

As shown in FIG. 36, in the electric transmission 201 of the present embodiment, the magnetic modulation element 215 of the first rotary machine M21 is coupled to the first rotary shaft 202 via the first rotor disc 216. The field element 214 and the second rotor 218 of the second rotary machine M22 are mechanically coupled to each other via the second rotor disc 219. The field element 214 is supported at the axial front side (left side of FIG. 36) via a bearing (fourth bearing) 245 in a rotatable manner with respect to the front frame 204.

The second rotor 218 is a squirrel-cage rotor. The first three-phase windings X1, Y1, Z1 of the first armature 213 and the second three-phase windings X2, Y2, Z2 of the second armature 217 are connected to each other in such a manner that their phase sequence is a negative sequence. This configuration is the same as the eighth exemplary embodiment.

According to a relationship of the number of poles based on the principle of magnetic modulation, the number of pole pairs of the field element 214 is smaller than the number of segment poles 224 of the magnetic modulation element 215. In the case of the eighth exemplary embodiment, the number of pole pairs of the field element 214 is n=10, and the number of segment poles 224 of the magnetic modulation element 215 is 16.

In the case of the present embodiment, a rotating speed of the field element 214 is higher than the engine speed, compared to the case of eighth exemplary embodiment in which the field element 214 is coupled to the first rotary shaft 202. Therefore, the two rotors (the field element 214 and the second rotor 218) coupled to each other via the second rotor disc 219 rotate at a speed higher than the engine speed. This enables the second rotary machine M22 to be tailored to high speed and to be downsized. In addition, due to a relationship that a rotating speed of the propeller shaft 209 is higher than a rotating speed of the engine E21, the engine speed can be reduced during high speed driving using engine power, thereby resulting in fuel saving.

In the second rotary machine M22 of the eighth and ninth exemplary embodiments, the armature core of the second armature 217 is configured by: (i) the outer armature core 226 located at the outer periphery of the second rotor element 218; and (ii) the inner armature core 227 located at the inner periphery of the second rotor element 218. This structure is so called a motor structure with a double face gap (two face gap) that forms a gap at the respective inner and outer peripheries of the second rotor element 218. In the exemplary embodiments described above, this motor structure with two-face gap is applied. In modifications of the embodiments described above, so called a motor structure with a triple face gap (three face gap) may be applied to the present disclosure. In this motor structure, another gap is further formed with the second armature 217, at the axial rear side of the second rotor 218.

In another modifications, an ordinary used motor structure with a single face gap (one face gap) may be also applied to the present disclosure. In this motor structure, a redundant space can be formed inside of the second rotary machine M22. In this case, the bearing 208 or the like can be located in the redundant space. Due to such an effective use of space, a mounting space for the inverter 230 and the rectifier 233 can be ensured.

### (Modifications)

In the second armature 218 of the eighth exemplary embodiment, the outer and inner armatures cores 226 and 227 are linked in the form of an approximately U-shaped cross section and integrally configured. Alternately, the outer and inner armature cores 226 and 227 may be separately provided without being connected to each other.

In the eighth exemplary embodiment, the magnetic modulation element 215 is configured by a die-cast product which is integrally produced by casting the 16 segment poles 127 in high-strength aluminum material. However, there is no need to produce the magnetic modulation element 215 by die-casting. For example, the magnetic modulation element 215 may be formed by annularly connecting the 16 segment poles 224 by use of a connecting member, for example, non-magnetic mechanical structural member such as stainless steel.

In the configuration of the ninth exemplary embodiment, the magnetic modulation element 215 may be configured by: (i) forming the first rotary shaft 202 by use of high-strength non-magnetic stainless steel; and (ii) directly fixing the 16 segment poles 224 to the first rotary shaft 202 by welding or the like.

The present invention may be embodied in several other forms without departing from the spirit thereof. The exemplary embodiments and modifications described so far are therefore intended to be only illustrative and not restrictive, since the scope of the invention is defined by the appended claims rather than by the description preceding them. All changes that fall within the metes and bounds of the claims, or equivalents of such metes and bounds, are therefore intended to be embraced by the claims.

What is claimed is:

1. A magnetic modulation motor, comprising:
an armature provided with a multi-phase winding having m pole pairs, n being an integer of one or more;
a magnetic induction rotor including k magnetic paths, k being an integer of one or more; and
a magnet rotor in which 2n permanent magnets forming a polarity region having n pole pairs are separately and annularly placed, n being a sum or difference of m and k,
wherein:
the armature, the magnet rotor, and the magnetic induction rotor are arranged in the order from a radially outer side to a radially inner side of the magnetic modulation motor;
in the magnetic induction rotor,
each of the magnetic paths has two ends, each projecting toward a magnetic flux entry and exit located at an outer diameter face of the magnetic induction rotor, each of the magnetic paths forming a magnetic flux path between the magnetic flux entry and exit; and
the magnet rotor includes a magnetic flux penetration region which is magnetically penetrated by magnetic flux between each circumferentially adjacent two permanent magnets.

2. The magnetic modulation motor according to claim 1, wherein:
the magnet rotor includes:
a ring-like soft magnetic material that is located around the circumference of the magnet rotor in such a way as to cover a radially outer surface of the 2n permanent magnets; and
a plurality of interpolar soft magnetic materials that are placed at a radially inside of the ring-like soft magnetic material and are located between each circumferentially adjacent two permanent magnets, the interpolar soft magnetic materials forming the magnetic flux penetration region.

3. The magnetic modulation motor according to claim 2, wherein:
the magnetic flux entry and exit is configured by satisfying a relationship defined by the following formula (I):
W1≦W2 (1)
where W1 denotes a circumferential width of the magnetic flux entry and exit, and W2 denotes a circumferential distance between each circumferentially adjacent two permanent magnets along an inner diameter surface of the magnet rotor.

4. The magnetic modulation motor according to claim 3, wherein:
in each of the magnetic paths, a concave portion is formed between the magnetic flux entry and exit, the concave portion being hollowed toward an inner diameter direction from an outer diameter surface of the magnetic induction rotor;
each of the magnetic paths is configured by satisfying a relationship defined by the following formula:
D≧W2 (2)
where D denotes a depth from an outer diameter surface to a bottom surface of the concave portion, and W2 denotes a circumferential distance between each circumferentially adjacent two permanent magnets along an inner diameter surface of the magnet rotor.

5. The magnetic modulation motor according to claim 4, wherein:
in the magnetic induction rotor,
each of the magnetic paths is configured by k segments made of soft magnetic material, and
the k segments are magnetically separated from one another, and are circumferentially arranged at regular intervals.

6. The magnetic modulation motor according to claim 5, wherein:
in the magnetic induction rotor,
the k segments are integrally fixed by aluminum material, and
the aluminum material is placed between each circumferential adjacent two segments.

7. The magnetic modulation motor according to claim 6, wherein:
the aluminum material fixing the k segments configures a rotor hub (10) that fixes the magnetic induction rotor to a rotary shaft.

8. The magnetic modulation motor according to claim 4, wherein:
the magnetic induction rotor includes k tooth-shaped portions that project radially outside,
the k tooth-shaped portions are formed of gear-shaped soft magnetic material which are circumferentially arranged at regular intervals, and have an apical surface facing the magnet rotor via a gap and forming an entry and exit of magnetic flux.

9. An electric transmission, comprising:
a first rotary machine including a first rotary shaft supported by a device frame via a first bearing in a rotatable manner; and
a second rotary machine including a second rotary shaft (103) supported by the device frame via a second bearing,
wherein:
the first rotary machine includes:
a first armature fixed to the device frame,
the first armature having three-phase windings having m pole pairs, m being an integer of one or more;
a first field element including a plurality of permanent magnets,
the permanent magnets being circumferentially arranged relative to the first armature via a gap in a rotatable manner,
the permanent magnets forming a plurality of magnetic poles having n pole pairs, n being an integer of one or more,
each circumferentially adjacent two permanent magnets being magnetized so as to differ in polarity from each other, and
a soft magnetic material being located around the circumference of an opposite surface facing the first armature so as to cover an armature side surface of the permanent magnets and a space between each circumferentially adjacent two permanent magnets; and
a magnetic modulation element including m+n magnetic paths,
the m+n magnetic paths being located relative to the first field element via a gap in a rotatable manner,
the m+n magnetic paths forming paths of magnetic flux, and
the m+n magnetic paths being magnetically separated from one another;
the first field element is located between the first armature and the magnetic modulation element;
the first field element and the magnetic modulation element configures two rotors, one of which being coupled to the first rotary shaft and being configured to rotate integrally with the first rotary shaft;
the second rotary machine includes:
a second armature fixed to the device frame,
the second armature having a three-phase winding;
a second field element located relative to the second armature via a gap in a rotatable manner,
the second field element circumferentially forming a plurality of magnetic poles, and
the circumferentially adjacent two magnetic poles differing in polarity from each other;
the second field element is connected to the second rotary shaft via a connecting member, and is configured to rotate integrally with the second rotary shaft;
in the first and second rotary machines, the second field element and the other of the first field element and the magnetic modulation element are mechanically connected to each other via the connecting member.

10. The electric transmission according to claim 9, wherein:
the m+n magnetic paths are configured by m+n segment poles that are mechanically held by non-magnetic metal material.

11. The electric transmission according to claim 10, wherein:
the device frame includes a front frame and a rear frame, the front frame supporting the first rotary shaft via the first bearing, the rear frame supporting the second rotary shaft via the second bearing; and
the first and second rotary machines are integrally contained in an internal space of the device frame which is formed by an axial combination of the front frame and the rear frame.

12. The electric transmission according to claim 11, wherein:
in the first rotary machine, the first armature is located radially outside the first field element, the magnetic modulation element is located radially inside the first field element, and the magnetic modulation element is mechanically connected to the second field element via the connecting member;
the first field element is connected to the first rotary shaft at one axial end, and is supported at the other axial end via a third bearing in a rotatable manner with respect to the connecting member; and
the connecting member includes a cylindrical boss section at its radially central portion that extends toward an inner diameter side of the third bearing, the cylindrical boss section being fitted in an outer periphery of the second rotary shaft and rotating integrally with the second rotary shaft.

13. The electric transmission according to claim 11, wherein:
in the first rotary machine, the first armature is located radially outside the first field element, the magnetic modulation element is located radially inside the first field element, and the magnetic modulation element is connected to the first rotary shaft and rotates integrally with the first rotary shaft;
the first field element is supported at one axial end via a fourth bearing in a rotatable manner with respect to the device frame, and is mechanically connected to the second field element at the other axial end via the connecting member; and
the connecting member includes a cylindrical boss section at its radially central portion that extends toward an inner diameter side from a connection portion that connects the first field element and the second field element, the cylindrical boss section being fitted in an outer periphery of the second rotary shaft and rotating integrally with the second rotary shaft.

14. The electric transmission according to claim 13, wherein:
the second bearing has a fifth bearing and a sixth bearing which are axially spaced at a predetermined axial distance;
the fifth bearing is located adjacent to the cylindrical boss section at one axial end of the second rotary shaft; and
the sixth bearing is located at the other axial end of the second rotary shaft.

15. An electric transmission, comprising:
a first rotary machine including a first rotary shaft supported by a device frame via a first bearing in a rotatable manner; and
a second rotary machine including a second rotary shaft supported by the device frame via a second bearing,
wherein:
the first rotary machine includes:
a first armature including a first armature core fixed to the device frame, and first three-phase windings having m pole pairs that is wound around the first armature core, m being an integer of one or more;
a field element including a plurality of permanent magnets,
the permanent magnets being circumferentially arranged relative to the first armature via a gap in a rotatable manner,
the permanent magnets forming a plurality of magnetic poles having n pole pairs, n being an integer of one or more,
each circumferentially adjacent two permanent magnets being magnetized so as to differ in polarity from each other, and
a soft magnetic material being located around the circumference of an opposite surface facing the first armature so as to cover an armature side surface of the permanent magnets and a space between each circumferentially adjacent two permanent magnets; and
a magnetic modulation element including m+n magnetic paths,
the m+n magnetic paths being located relative to the field element via a gap in a rotatable manner,
the m+n magnetic paths forming paths of magnetic flux, and
the m+n magnetic paths being magnetically separated from one another and being arranged;
the field element is located between the first armature and the magnetic modulation element;
the field element and the magnetic modulation element configures two rotors, one of which is configured to rotate integrally with the first rotary shaft via a first rotor disc;
the second rotary machine includes:
a second armature including a second armature core fixed to the device frame and second three-phase windings that are wound around the second armature core;
a squirrel-cage rotor located relative to the second armature via a gap in a rotatable manner, the squirrel-cage rotor being configured to rotate integrally with the second rotary shaft via a second rotor disc;
in the first and second rotary machines, the squirrel-cage rotor and the other of the field element and the magnetic modulation element are mechanically connected to each other; and
the first three-phase windings and the second three-phase windings are connected to each other in such a manner that their phase sequence is a negative sequence.

16. The electric transmission according to claim 15, further comprising:
three-phase connection points defined as connection points per phase at which the first three-phase windings and the second three-phase windings are connected to each other in such a manner that their phase sequence is a negative sequence;
first three-phase terminals defined as three-phase terminals of the first three-phase windings on the side opposite to the three-phase connection points;
second three-phase terminals defined as three-phase terminals of the second three-phase windings on the side opposite to the three-phase connection points;
an inverter connected to three-phase connection points via a three-phase harness;
a three-phase full-wave rectifier connected to the second three-phase terminals via a three-phase harness;
a short-circuit for causing short circuit between positive and negative terminals of the three-phase full-wave rectifier; and
a shorting switching element that is inserted in the short-circuit and turns on and off the short-circuit,
the first three-phase windings is configured by a star connection in which a neutral point is formed by the first three-phase terminals.

17. The electric transmission according to claim 16, wherein:
the m+n magnetic paths are configured by m+n segment poles that are mechanically held by non-magnetic metal material.

18. The electric transmission according to claim 17, wherein:
the device frame includes a front frame and a rear frame, the front frame supporting the first rotary shaft via the first bearing, the rear frame supporting the second rotary shaft via the second bearing; and
the first and second rotary machines are integrally contained in an internal space of the device frame which is formed by an axial combination of the front frame and the rear frame.

19. The electric transmission according to claim 18, wherein:
in the first rotary machine, the first armature is located radially outside the field element, the magnetic modulation element is located radially inside the field element, and the magnetic modulation element is mechanically connected to the squirrel-cage rotor via the second rotor disc;
the field element is connected to the first rotary shaft at one axial end via the first rotor disc, and is supported at the other axial end via a third bearing in a rotatable manner with respect to the second rotor disc; and
the second rotor disc includes a cylindrical boss section at its radially central portion that extends toward an inner diameter side of the third bearing, the cylindrical boss section being fitted in an outer periphery of the second rotary shaft and rotating integrally with the second rotary shaft.

20. The electric transmission according to claim 19, wherein:
in the first rotary machine, the first armature is located radially outside the field element, the magnetic modulation element is located radially inside the field element, and the magnetic modulation element is connected to the first rotary shaft via the first rotor disc;
the field element is supported at one axial end via a fourth bearing in a rotatable manner with respect to the device frame, and is mechanically connected to the squirrel-cage rotor at the other axial end via the second rotor disc; and
the second rotor disc includes a cylindrical boss section at its radially central portion that extends toward an inner diameter side from a connection portion that connects the field element and the squirrel-cage rotor, the cylindrical boss section being fitted in an outer periphery of the second rotary shaft and rotating integrally with the second rotary shaft.
